(19) United States
(12) Patent Application Publication
(10) Pub. No.: US 2023/0094454 A1
(43) Pub. Date: Mar. 30, 2023

(54) OPTICAL IMAGING LENS

(71) Applicant: Genius Electronic Optical (Xiamen) Co., Ltd., Xiamen (CN)

(72) Inventors: Maozong Lin, Xiamen (CN); Baina Chen, Xiamen (CN); Zhao Wang, Xiamen (CN)

(73) Assignee: Genius Electronic Optical (Xiamen) Co., Ltd., Xiamen (CN)

(21) Appl. No.: 17/522,936

(22) Filed: Nov. 10, 2021

(30) Foreign Application Priority Data
Sep. 30, 2021 (CN) 202111158552.1

(51) Int. Cl. G02B 9/62; G02B 13/00

(52) U.S. Cl. CPC G02B 9/62; G02B 13/0045; G02B 13/14

(57) ABSTRACT

An optical imaging lens includes a first lens element to a sixth lens element from an object side to an image side along an optical axis. A periphery region of the object-side surface of the first lens element is concave, an optical axis of the image-side surface of the first lens element is concave, a periphery region of the object-side surface of the second lens element is convex, the third lens element has negative refracting power, the fourth lens element has negative refracting power, a periphery region of the image-side surface of the fourth lens element is concave, and a periphery region of the object-side surface of the fifth lens element is concave. Lens elements included by the optical imaging lens are only six lens elements described above.

### BACKGROUND OF THE INVENTION

### 1. Field of the Invention

The present invention generally relates to an optical imaging lens. Specifically speaking, the present invention is directed to an optical imaging lens for using in portable electronic devices, such as a mobile phone, a camera, a tablet personal computer, or a personal digital assistant (PDA) and for taking pictures or for recording videos.

### 2. Description of the Prior Art

In recent years, an optical imaging lens is developing, and a light, thin and short product with large field of view has gradually become market trends. In order to make more diverse applications possible, such as video surveillance, or to make the night vision function better to yield sharper images, the confocal design of visible light and of infrared light helps to achieve these goals.

However, the best focal planes of visible light and of infrared light are far from each other. If a compensation lens element is inserted to compensate the difference between the focus of visible light and of infrared light, the system length would be accordingly longer. Therefore, how to design an optical imaging lens with good imaging quality, short system length, and the ability of closer confocal planes of visible light and of infrared light has become a target for research.

### SUMMARY OF THE INVENTION

Accordingly, to solve the above problems, various embodiments of the present invention propose an optical imaging lens to have the ability of closer confocal planes of visible light and of infrared light while maintaining the system length. The present invention may propose an optical imaging lens of six lens elements, of good imaging quality and of short system length. The optical imaging lens of six lens elements of the present invention from an object side to an image side in order along an optical axis has a first lens element, a second lens element, a third lens element, a fourth lens element, a fifth lens element and a sixth lens element. Each first lens element, second lens element, third lens element, fourth lens element, fifth lens element and sixth lens element has an object-side surface which faces toward the object side and allows imaging rays to pass through as well as an image-side surface which faces toward the image side and allows the imaging rays to pass through.

In one embodiment, a periphery region of the object-side surface of the first lens element is concave, and an optical axis region of the image-side surface of the first lens element is concave; a periphery region of the object-side surface of the second lens element is convex; the third lens element has negative refracting power; the fourth lens element has negative refracting power and a periphery region of the image-side surface of the fourth lens element is concave; and a periphery region of the object-side surface of the fifth lens element is concave. Lens elements included by the optical imaging lens are only the six lens elements described above.

In another embodiment, a periphery region of the object-side surface of the first lens element is concave, and an optical axis region of the image-side surface of the first lens element is concave; the second lens element has positive refracting power and a periphery region of the object-side surface of the second lens element is convex; the fourth lens element has negative refracting power and an optical axis region of the image-side surface of the fourth lens element is concave; and an optical axis region of the object-side surface of the fifth lens element is concave. Lens elements included by the optical imaging lens are only the six lens elements described above.

In still another embodiment, a periphery region of the object-side surface of the first lens element is concave, and an optical axis region of the image-side surface of the first lens element is concave; a periphery region of the object-side surface of the second lens element is convex; the fourth lens element has negative refracting power and an optical axis region of the image-side surface of the fourth lens element is concave; an optical axis region of the object-side surface of the fifth lens element is concave; and a periphery region of the image-side surface of the sixth lens element is convex. Lens elements included by the optical imaging lens are only the six lens elements described above.

In the optical imaging lens of the present invention, the embodiments may also selectively satisfy the following conditions:

(G34+T5)/T≥34.000; (1)

v1+v3+v6≥120.000; (2)

EFL/BFL≤2.800; (3)

ALT/(G34+G56+T6)≤300; (4)

(T5+T6)/(T1+G12)≥2.800; (5)

v1+v4+v≥120.000; (6)

EFL/(T2+G45)≥4.400; (7)

HFOV/TTL≥7.600 degrees/mm; (8)

(T1+T2+T3+T4)/T6≤3.000; (9)

AAG/T5≤1.500; (10)

(T2+G23)/T3≥1.500; (11)

TL/(T6+BFL)≤2.500; (12)

(T2+G34)/T1≥2.400; (13)

EFL/(T2+T5)≤3.200; (14)

(T2+G45)/T3≤3.500; (15)
(16) an air gap between the third lens element and the fourth lens element along the optical axis is greater than a thickness of the fourth lens element along the optical axis;
(17) an air gap between the third lens element and the fourth lens element along the optical axis is greater than a thickness of the third lens element along the optical axis.

In order to facilitate clearness of the parameters represented by the present invention and the drawings, it is defined in this specification and the drawings: v1 is an Abbe number of the first lens element, v3 is an Abbe number of the third lens element, v4 is an Abbe number of the fourth lens element and v6 is an Abbe number of the sixth lens element. T1 is a thickness of the first lens element along the optical axis; T2 is a thickness of the second lens element along the optical axis; T3 is a thickness of the third lens element along the optical axis; T4 is a thickness of the fourth lens element along the optical axis; T5 is a thickness of the fifth lens element along the optical axis; and T6 is a thickness of the sixth lens element along the optical axis.

G12 is an air gap between the first lens element and the second lens element along the optical axis; G23 is an air gap between the second lens element and the third lens element along the optical axis; G34 is an air gap between the third lens element and the fourth lens element along the optical axis; G45 is an air gap between the fourth lens element and the fifth lens element along the optical axis; G56 is an air gap between the fifth lens element and the sixth lens element along the optical axis. ALT is a sum of thicknesses of all the six lens elements along the optical axis. TL is a distance from the object-side surface of the first lens element to the image-side surface of the sixth lens element along the optical axis. TTL is a distance from the object-side surface of the first lens element to an image plane along the optical axis. BFL is a distance from the image-side surface of the sixth lens element to the image plane along the optical axis. AAG is a sum of five air gaps from the first lens element to the sixth lens element along the optical axis. EFL is an effective focal length of the optical imaging lens. ImgH is an image height of the optical imaging lens. Fno is an f-number of the optical imaging lens. HFOV is a half field of view of the optical imaging lens.

The present invention may provide an optical imaging lens with short lens system length, large field of view, good imaging quality, and the ability of closer confocal planes of visible light and of infrared light. The distance difference between the best focus planes of visible light and of infrared light may be less than 0.020 mm.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-5 illustrate the methods for determining the surface shapes and for determining optical axis region or periphery region of one lens element.

FIG. 6 illustrates a first embodiment of the optical imaging lens of the present invention.

FIG. 7A illustrates the longitudinal spherical aberration on the image plane of the first embodiment.

FIG. 7B illustrates the field curvature aberration on the sagittal direction of the first embodiment.

FIG. 7C illustrates the field curvature aberration on the tangential direction of the first embodiment.

FIG. 7D illustrates the distortion aberration of the first embodiment.

FIG. 8 illustrates a second embodiment of the optical imaging lens of the present invention.

FIG. 9A illustrates the longitudinal spherical aberration on the image plane of the second embodiment.

FIG. 9B illustrates the field curvature aberration on the sagittal direction of the second embodiment.

FIG. 9C illustrates the field curvature aberration on the tangential direction of the second embodiment.

FIG. 9D illustrates the distortion aberration of the second embodiment.

FIG. 10 illustrates a third embodiment of the optical imaging lens of the present invention.

FIG. 11A illustrates the longitudinal spherical aberration on the image plane of the third embodiment.

FIG. 11B illustrates the field curvature aberration on the sagittal direction of the third embodiment.

FIG. 11C illustrates the field curvature aberration on the tangential direction of the third embodiment.

FIG. 11D illustrates the distortion aberration of the third embodiment.

FIG. 12 illustrates a fourth embodiment of the optical imaging lens of the present invention.

FIG. 13A illustrates the longitudinal spherical aberration on the image plane of the fourth embodiment.

FIG. 13B illustrates the field curvature aberration on the sagittal direction of the fourth embodiment.

FIG. 13C illustrates the field curvature aberration on the tangential direction of the fourth embodiment.

FIG. 13D illustrates the distortion aberration of the fourth embodiment.

FIG. 14 illustrates a fifth embodiment of the optical imaging lens of the present invention.

FIG. 15A illustrates the longitudinal spherical aberration on the image plane of the fifth embodiment.

FIG. 15B illustrates the field curvature aberration on the sagittal direction of the fifth embodiment.

FIG. 15C illustrates the field curvature aberration on the tangential direction of the fifth embodiment.

FIG. 15D illustrates the distortion aberration of the fifth embodiment.

FIG. 16 illustrates a sixth embodiment of the optical imaging lens of the present invention.

FIG. 17A illustrates the longitudinal spherical aberration on the image plane of the sixth embodiment.

FIG. 17B illustrates the field curvature aberration on the sagittal direction of the sixth embodiment.

FIG. 17C illustrates the field curvature aberration on the tangential direction of the sixth embodiment.

FIG. 17D illustrates the distortion aberration of the sixth

FIG. 18 illustrates a seventh embodiment of the optical imaging lens of the present invention.

FIG. 19A illustrates the longitudinal spherical aberration on the image plane of the seventh embodiment.

FIG. 19B illustrates the field curvature aberration on the sagittal direction of the seventh embodiment.

FIG. 19C illustrates the field curvature aberration on the tangential direction of the seventh embodiment.

FIG. 19D illustrates the distortion aberration of the seventh embodiment.

FIG. 20 illustrates an eighth embodiment of the optical imaging lens of the present invention.

FIG. 21A illustrates the longitudinal spherical aberration on the image plane of the eighth embodiment.

FIG. 21B illustrates the field curvature aberration on the sagittal direction of the eighth embodiment.

FIG. 21C illustrates the field curvature aberration on the tangential direction of the eighth embodiment.

FIG. 21D illustrates the distortion aberration of the eighth embodiment.

FIG. 22 illustrates a ninth embodiment of the optical imaging lens of the present invention.

FIG. 23A illustrates the longitudinal spherical aberration on the image plane of the ninth embodiment.

FIG. 23B illustrates the field curvature aberration on the sagittal direction of the ninth embodiment.

FIG. 23C illustrates the field curvature aberration on the tangential direction of the ninth embodiment.

FIG. 23D illustrates the distortion aberration of the ninth embodiment.

FIG. 24 illustrates a tenth embodiment of the optical imaging lens of the present invention.

FIG. 25A illustrates the longitudinal spherical aberration on the image plane of the tenth embodiment.

FIG. 25B illustrates the field curvature aberration on the sagittal direction of the tenth embodiment.

FIG. 25C illustrates the field curvature aberration on the tangential direction of the tenth embodiment.

FIG. 25D illustrates the distortion aberration of the tenth embodiment.

FIG. 26 illustrates an eleventh embodiment of the optical imaging lens of the present invention.

FIG. 27A illustrates the longitudinal spherical aberration on the image plane of the eleventh embodiment.

FIG. 27B illustrates the field curvature aberration on the sagittal direction of the eleventh embodiment.

FIG. 27C illustrates the field curvature aberration on the tangential direction of the eleventh embodiment.

FIG. 27D illustrates the distortion aberration of the eleventh embodiment.

FIG. 28 illustrates a twelfth embodiment of the optical imaging lens of the present invention.

FIG. 29A illustrates the longitudinal spherical aberration on the image plane of the twelfth embodiment.

FIG. 29B illustrates the field curvature aberration on the sagittal direction of the twelfth embodiment.

FIG. 29C illustrates the field curvature aberration on the tangential direction of the twelfth embodiment.

FIG. 29D illustrates the distortion aberration of the twelfth embodiment.

FIG. 30 shows the optical data of the first embodiment of the optical imaging lens.

FIG. 31 shows the aspheric surface data of the first embodiment.

FIG. 32 shows the optical data of the second embodiment of the optical imaging lens.

FIG. 33 shows the aspheric surface data of the second embodiment.

FIG. 34 shows the optical data of the third embodiment of the optical imaging lens.

FIG. 35 shows the aspheric surface data of the third embodiment.

FIG. 36 shows the optical data of the fourth embodiment of the optical imaging lens.

FIG. 37 shows the aspheric surface data of the fourth embodiment.

FIG. 38 shows the optical data of the fifth embodiment of the optical imaging lens.

FIG. 39 shows the aspheric surface data of the fifth embodiment.

FIG. 40 shows the optical data of the sixth embodiment of the optical imaging lens.

FIG. 41 shows the aspheric surface data of the sixth embodiment.

FIG. 42 shows the optical data of the seventh embodiment of the optical imaging lens.

FIG. 43 shows the aspheric surface data of the seventh embodiment.

FIG. 44 shows the optical data of the eighth embodiment of the optical imaging lens.

FIG. 45 shows the aspheric surface data of the eighth embodiment.

FIG. 46 shows the optical data of the ninth embodiment of the optical imaging lens.

FIG. 47 shows the aspheric surface data of the ninth embodiment.

FIG. 48 shows the optical data of the tenth embodiment of the optical imaging lens.

FIG. 49 shows the aspheric surface data of the tenth embodiment.

FIG. 50 shows the optical data of the eleventh embodiment of the optical imaging lens.

FIG. 51 shows the aspheric surface data of the eleventh embodiment.

FIG. 52 shows the optical data of the twelfth embodiment of the optical imaging lens.

FIG. 53 shows the aspheric surface data of the twelfth embodiment.

FIG. 54, FIG. 55 and FIG. 56 show some important parameters and ratios in the embodiments.

### DETAILED DESCRIPTION

The terms “optical axis region”, “periphery region”, “concave”, and “convex” used in this specification and claims should be interpreted based on the definition listed in the specification by the principle of lexicographer.

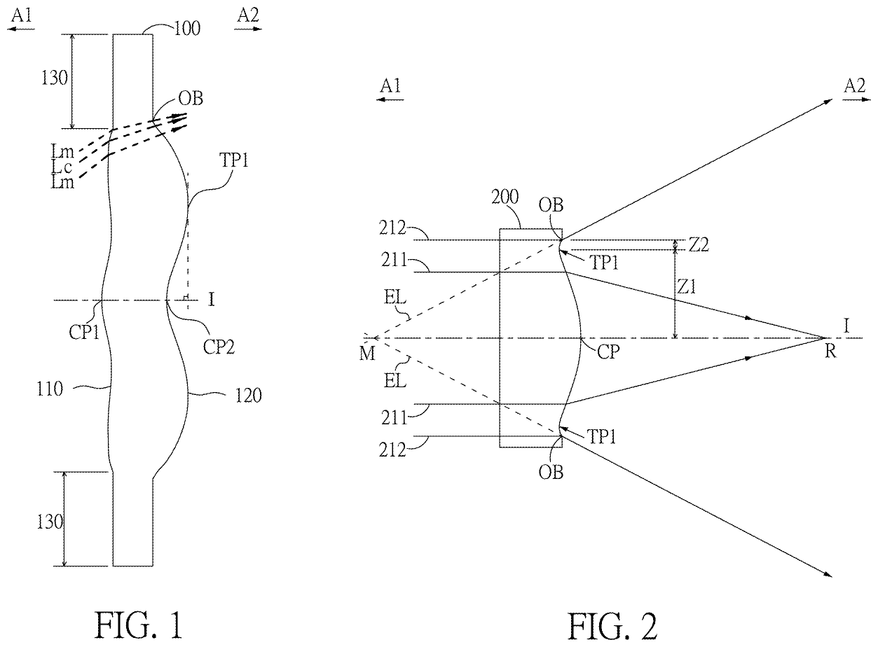

In the present disclosure, the optical system may comprise at least one lens element to receive imaging rays that are incident on the optical system over a set of angles ranging from parallel to an optical axis to a half field of view (HFOV) angle with respect to the optical axis. The imaging rays pass through the optical system to produce an image on an image plane. The term “a lens element having positive refracting power (or negative refracting power) ” means that the paraxial refracting power of the lens element in Gaussian optics is positive (or negative). The term “an object-side (or image-side) surface of a lens element” refers to a specific region of that surface of the lens element at which imaging rays can pass through that specific region. Imaging rays include at least two types of rays: a chief ray Lc and a marginal ray Lm (as shown in FIG. 1). An object-side (or image-side) surface of a lens element can be characterized as having several regions, including an optical axis region, a periphery region, and, in some cases, one or more intermediate regions, as discussed more fully below.

FIG. 1 is a radial cross-sectional view of a lens element 100. Two referential points for the surfaces of the lens element 100 can be defined: a central point, and a transition point. The central point of a surface of a lens element is a point of intersection of that surface and the optical axis I. As illustrated in FIG. 1, a first central point CP1 may be present on the object-side surface 110 of lens element 100 and a second central point CP2 may be present on the image-side surface 120 of the lens element 100. The transition point is a point on a surface of a lens element, at which the line tangent to that point is perpendicular to the optical axis I. The optical boundary OB of a surface of the lens element is defined as a point at which the radially outermost marginal ray Lm passing through the surface of the lens element intersects the surface of the lens element. All transition points lie between the optical axis I and the optical boundary OB of the surface of the lens element. A surface of the lens element 100 may have no transition point or have at least one transition point. If multiple transition points are present on a single surface, then these transition points are sequentially named along the radial direction of the surface with reference numerals starting from the first transition point. For example, the first transition point, e.g., TP1, (closest to the optical axis I), the second transition point, e.g., TP2, (as shown in FIG. 4), and the Nth transition point (farthest from the optical axis I).

When a surface of the lens element has at least one transition point, the region of the surface of the lens element from the central point to the first transition point TP1 is defined as the optical axis region, which includes the central point. The region located radially outside of the farthest transition point (the Nth transition point) from the optical axis I to the optical boundary OB of the surface of the lens element is defined as the periphery region. In some embodiments, there may be intermediate regions present between the optical axis region and the periphery region, with the number of intermediate regions depending on the number of the transition points. When a surface of the lens element has no transition point, the optical axis region is defined as a region of 0%-50% of the distance between the optical axis I and the optical boundary OB of the surface of the lens element, and the periphery region is defined as a region of 50%-100% of the distance between the optical axis I and the optical boundary OB of the surface of the lens element.

The shape of a region is convex if a collimated ray being parallel to the optical axis I and passing through the region is bent toward the optical axis I such that the ray intersects the optical axis I on the image side A2 of the lens element. The shape of a region is concave if the extension line of a collimated ray being parallel to the optical axis I and passing through the region intersects the optical axis I on the object side A1 of the lens element.

Additionally, referring to FIG. 1, the lens element 100 may also have a mounting portion 130 extending radially outward from the optical boundary OB. The mounting portion 130 is typically used to physically secure the lens element to a corresponding element of the optical system (not shown). Imaging rays do not reach the mounting portion 130. The structure and shape of the mounting portion 130 are only examples to explain the technologies, and should not be taken as limiting the scope of the present disclosure. The mounting portion 130 of the lens elements discussed below may be partially or completely omitted in the following drawings.

Referring to FIG. 2, optical axis region Z1 is defined between central point CP and first transition point TP1. Periphery region Z2 is defined between TP1 and the optical boundary OB of the surface of the lens element. Collimated ray 211 intersects the optical axis I on the image side A2 of lens element 200 after passing through optical axis region Z1, i.e., the focal point of collimated ray 211 after passing through optical axis region Z1 is on the image side A2 of the lens element 200 at point R in FIG. 2. Accordingly, since the ray itself intersects the optical axis I on the image side A2 of the lens element 200, optical axis region Z1 is convex. On the contrary, collimated ray 212 diverges after passing through periphery region Z2. The extension line EL of collimated ray 212 after passing through periphery region Z2 intersects the optical axis I on the object side A1 of lens element 200, i.e., the focal point of collimated ray 212 after passing through periphery region Z2 is on the object side A1 at point M in FIG. 2. Accordingly, since the extension line EL of the ray intersects the optical axis I on the object side A1 of the lens element 200, periphery region Z2 is concave. In the lens element 200 illustrated in FIG. 2, the first transition point TP1 is the border of the optical axis region and the periphery region, i.e., TP1 is the point at which the shape changes from convex to concave.

Alternatively, there is another way for a person having ordinary skill in the art to determine whether an optical axis region is convex or concave by referring to the sign of “Radius of curvature” (the “R” value), which is the paraxial radius of shape of a lens surface in the optical axis region. The R value is commonly used in conventional optical design software such as Zemax and CodeV. The R value usually appears in the lens data sheet in the software. For an object-side surface, a positive R value defines that the optical axis region of the object-side surface is convex, and a negative R value defines that the optical axis region of the object-side surface is concave. Conversely, for an image-side surface, a positive R value defines that the optical axis region of the image-side surface is concave, and a negative R value defines that the optical axis region of the image-side surface is convex. The result found by using this method should be consistent with the method utilizing intersection of the optical axis by rays/extension lines mentioned above, which determines surface shape by referring to whether the focal point of a collimated ray being parallel to the optical axis I is on the object-side or the image-side of a lens element. As used herein, the terms “a shape of a region is convex (concave),” “a region is convex (concave),” and “a convex- (concave-) region,” can be used alternatively.

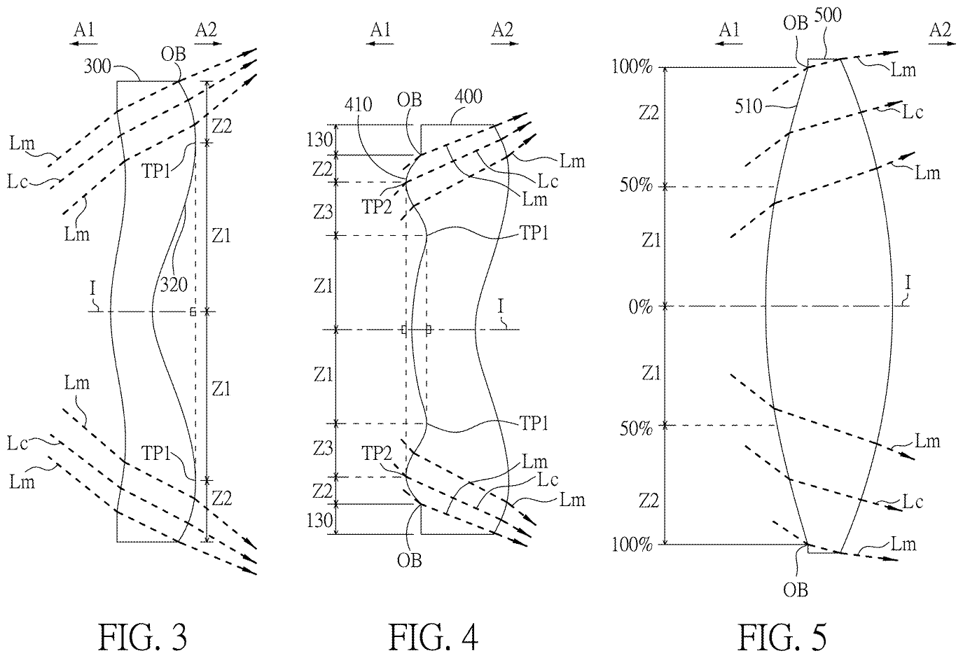

FIG. 3, FIG. 4 and FIG. 5 illustrate examples of determining the shape of lens element regions and the boundaries of regions under various circumstances, including the optical axis region, the periphery region, and intermediate regions as set forth in the present specification.

FIG. 3 is a radial cross-sectional view of a lens element 300. As illustrated in FIG. 3, only one transition point TP1 appears within the optical boundary OB of the image-side surface 320 of the lens element 300. Optical axis region Z1 and periphery region Z2 of the image-side surface 320 of lens element 300 are illustrated. The R value of the image-side surface 320 is positive (i.e., R>0). Accordingly, the optical axis region Z1 is concave.

In general, the shape of each region demarcated by the transition point will have an opposite shape to the shape of the adjacent region(s). Accordingly, the transition point will define a transition in shape, changing from concave to convex at the transition point or changing from convex to concave. In FIG. 3, since the shape of the optical axis region Z1 is concave, the shape of the periphery region Z2 will be convex as the shape changes at the transition point TP1.

FIG. 4 is a radial cross-sectional view of a lens element 400. Referring to FIG. 4, a first transition point TP1 and a second transition point TP2 are present on the object-side surface 410 of lens element 400. The optical axis region Z1 of the object-side surface 410 is defined between the optical axis I and the first transition point TP1. The R value of the object-side surface 410 is positive (i.e., R>0). Accordingly, the optical axis region Z1 is convex.

The periphery region Z2 of the object-side surface 410, which is also convex, is defined between the second transition point TP2 and the optical boundary OB of the object-side surface 410 of the lens element 400. Further, intermediate region Z3 of the object-side surface 410, which is concave, is defined between the first transition point TP1 and the second transition point TP2. Referring once again to FIG. 4, the object-side surface 410 includes an optical axis region Z1 located between the optical axis I and the first transition point TP1, an intermediate region Z3 located between the first transition point TP1 and the second transition point TP2, and a periphery region Z2 located between the second transition point TP2 and the optical boundary OB of the object-side surface 410. Since the shape of the optical axis region Z1 is designed to be convex, the shape of the intermediate region Z3 is concave as the shape of the intermediate region Z3 changes at the first transition point TP1, and the shape of the periphery region Z2 is convex as the shape of the periphery region Z2 changes at the second transition point TP2.

FIG. 5 is a radial cross-sectional view of a lens element 500. Lens element 500 has no transition point on the object-side surface 510 of the lens element 500. For a surface of a lens element with no transition point, for example, the object-side surface 510 the lens element 500, the optical axis region Z1 is defined as the region of 0%-50% of the distance between the optical axis I and the optical boundary OB of the surface of the lens element and the periphery region is defined as the region of 50%-100% of the distance between the optical axis I and the optical boundary OB of the surface of the lens element. Referring to lens element 500 illustrated in FIG. 5, the optical axis region Z1 of the object-side surface 510 is defined between the optical axis I and 50% of the distance between the optical axis I and the optical boundary OB. The R value of the object-side surface 510 is positive (i.e., R>0). Accordingly, the optical axis region Z1 is convex. For the object-side surface 510 of the lens element 500, because there is no transition point, the periphery region Z2 of the object-side surface 510 is also convex. It should be noted that lens element 500 may have a mounting portion (not shown) extending radially outward from the periphery region Z2.

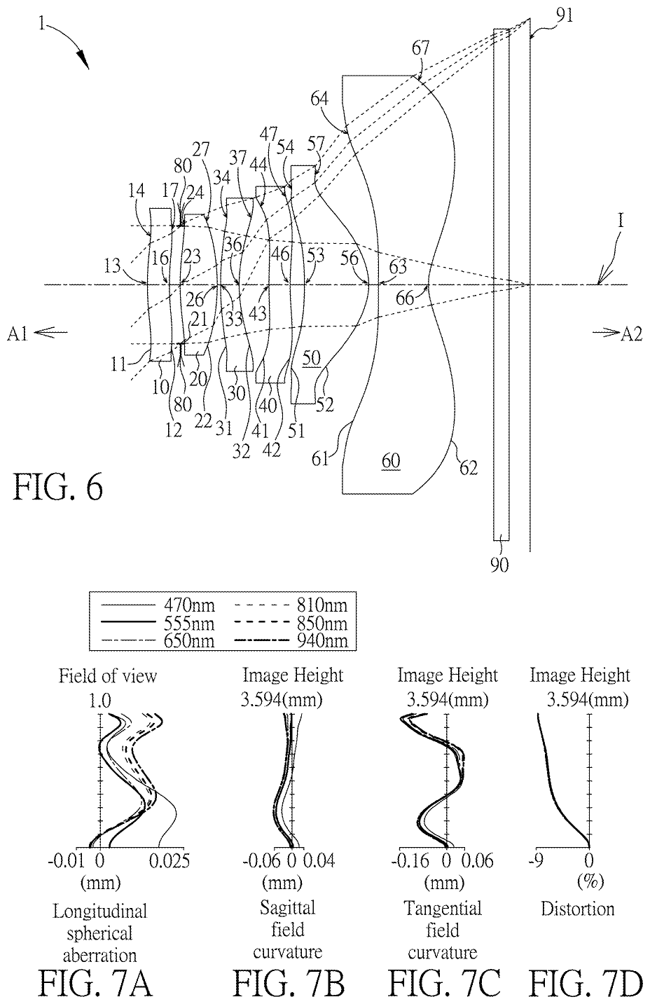

As shown in FIG. 6, the optical imaging lens 1 of the present invention, located from an object side A1 (where an object is located) to an image side A2 along an optical axis I, is mainly composed of six lens elements, sequentially has a first lens element 10, an aperture stop 80, a second lens element 20, a third lens element 30, a fourth lens element 40, a fifth lens element 50, a sixth lens element 60 and an image plane 91. Generally speaking, the first lens element 10, the second lens element 20, the third lens element 30, the fourth lens element 40, the fifth lens element 50 and the sixth lens element 60 may be made of a transparent plastic material but the present invention is not limited to this. In the optical imaging lens 1 of the present invention, lens elements included by the optical imaging lens 1 are only the six lens elements (the first lens element 10, the second lens element 20, the third lens element 30, the fourth lens element 40, the fifth lens element 50 and the sixth lens element 60) described above. The optical axis I is the optical axis of the entire optical imaging lens 1, and the optical axis of each of the lens elements coincides with the optical axis I of the optical imaging lens 1.

Furthermore, the optical imaging lens 1 further includes an aperture stop (ape. stop) 80 disposed in an appropriate position. In FIG. 6, the aperture stop 80 is disposed between the first lens element 10 and the second lens element 20. When imaging rays emitted or reflected by an object (not shown) which is located at the object side A1 enters the optical imaging lens 1 of the present invention, the imaging rays form a clear and sharp image on the image plane 91 at the image side A2 after passing through the first lens element 10, the aperture stop 80, the second lens element 20, the third lens element 30, the fourth lens element 40, the fifth lens element 50, the sixth lens element 60, and a filter 90. In the embodiments of the present invention, the filter 90 may be a filter of various suitable functions, placed between the sixth lens element 60 and the image plane 91 to filter out light of a specific wavelength, for some embodiments, the filter 90 may be a filter to keep light other than infrared light or visible light in the imaging rays from reaching the image plane 91 to jeopardize the imaging quality.

Each lens element of the optical imaging lens 1 has an object-side surface facing toward the object side A1 and allowing imaging rays to pass through as well as an image-side surface facing toward the image side A2 and allowing the imaging rays to pass through. In addition, each lens element of the optical imaging lens 1 has an optical axis region and a periphery region. For example, the first lens element 10 has an object-side surface 11 and an image-side surface 12; the second lens element 20 has an object-side surface 21 and an image-side surface 22; the third lens element 30 has an object-side surface 31 and an image-side surface 32; the fourth lens element 40 has an object-side surface 41 and an image-side surface 42; the fifth lens element 50 has an object-side surface 51 and an image-side surface 52; the sixth lens element 60 has an object-side surface 61 and an image-side surface 62. Furthermore, each object-side surface and image-side surface of lens elements in the optical imaging lens of present invention has an optical axis region and a periphery region.

Each lens element in the optical imaging lens 1 of the present invention further has a thickness T along the optical axis I. For embodiment, the first lens element 10 has a first lens element thickness T1, the second lens element 20 has a second lens element thickness T2, the third lens element 30 has a third lens element thickness T3, the fourth lens element 40 has a fourth lens element thickness T4, the fifth lens element 50 has a fifth lens element thickness T5, and the sixth lens element 60 has a sixth lens element thickness T6. Therefore, a sum of thicknesses of all the six lens elements from the first lens element 10 to the sixth lens element 60 in the optical imaging lens 1 along the optical axis I is ALT. In other words, ALT=T1+T2+T3+T4+T5+T6.

In addition, between two adjacent lens elements in the optical imaging lens 1 of the present invention there may be an air gap along the optical axis I. For example, there is an air gap G12 between the first lens element 10 and the second lens element 20, an air gap G23 between the second lens element 20 and the third lens element 30, an air gap G34 between the third lens element 30 and the fourth lens element 40, an air gap G45 between the fourth lens element 40 and the fifth lens element 50 as well as an air gap G56 between the fifth lens element 50 and the sixth lens element 60. Therefore, a sum of five air gaps from the first lens element 10 to the sixth lens element 60 along the optical axis I is AAG. In other words, AAG=G12+G23+G34+G45+G56.

In addition, a distance from the object-side surface 11 of the first lens element 10 to the image plane 91, namely a system length of the optical imaging lens 1 along the optical axis I is TTL. An effective focal length of the optical imaging lens is EFL. A distance from the object-side surface 11 of the first lens element 10 to the image-side surface 62 of the sixth lens element 60 along the optical axis I is TL. HFOV stands for the half field of view of the optical imaging lens 1, which is a half of the field of view. ImgH is an image height of the optical imaging lens 1. Fno is a f-number of the optical imaging lens 1.

When the filter 90 is placed between the sixth lens element 60 and the image plane 91, an air gap between the sixth lens element 60 and the filter 90 along the optical axis I is G6F; a thickness of the filter 90 along the optical axis I is TF; an air gap between the filter 90 and the image plane 91 along the optical axis I is GFP. BFL is the back focal length of the optical imaging lens 1, namely a distance from the image-side surface 62 of the sixth lens element 60 to the image plane 91 along the optical axis I. Therefore, BFL=G6F+TF+GFP.

Furthermore, a focal length of the first lens element 10 is f1; a focal length of the second lens element 20 is f2; a focal length of the third lens element 30 is f3; a focal length of the fourth lens element 40 is f4; a focal length of the fifth lens element 50 is f5; a focal length of the sixth lens element 60 is f6; a refractive index of the first lens element 10 is n1; a refractive index of the second lens element 20 is n2; a refractive index of the third lens element 30 is n3; a refractive index of the fourth lens element 40 is n4; a refractive index of the fifth lens element 50 is n5; a refractive index of the sixth lens element 60 is n6; an Abbe number of the first lens element 10 is v1; an Abbe number of the second lens element 20 is v2; an Abbe number of the third lens element 30 is v3; and an Abbe number of the fourth lens element 40 is v4; an Abbe number of the fifth lens element 50 is v5; and an Abbe number of the sixth lens element 60 is v6.

### First Embodiment

Please refer to FIG. 6 which illustrates the first embodiment of the optical imaging lens 1 of the present invention. Please refer to FIG. 7A for the longitudinal spherical aberration on the image plane 91 of the first embodiment; please refer to FIG. 7B for the field curvature aberration on the sagittal direction; please refer to FIG. 7C for the field curvature aberration on the tangential direction; and please refer to FIG. 7D for the distortion aberration. The Y axis of the spherical aberration in each embodiment is “field of view” for 1.0. The Y axis of the field curvature aberration and the distortion aberration in each embodiment stands for the “image height” (ImgH), which is 3.594 mm.

The optical imaging lens 1 in the first embodiment is mainly composed of six lens elements, an aperture stop 80, and an image plane 91. The aperture stop 80 in the first embodiment is provided between the first lens element 10 and the second lens element 20 so that the optical imaging lens 1 may have the advantages of good imaging quality without increasing the thickness of each lens element while maintaining a large field of view.

The first lens element 10 has positive refracting power. An optical axis region 13 of the object-side surface 11 of the first lens element 10 is convex and a periphery region 14 of the object-side surface 11 of the first lens element 10 is concave. An optical axis region 16 of the image-side surface 12 of the first lens element 10 is concave and a periphery region 17 of the image-side surface 12 of the first lens element 10 is convex. Besides, both the object-side surface 11 and the image-side surface 12 of the first lens element 10 are aspherical surfaces, but it is not limited thereto. A periphery region 14 of the object-side surface 11 of the first lens element 10 is concave to help recover rays of a large angle while the first lens element 10 is designed to have positive refracting power to help the convergence of the angle of the imaging rays to enter the second lens element 20 successfully.

The second lens element 20 has positive refracting power. An optical axis region 23 and a periphery region 24 of the object-side surface 21 of the second lens element 20 are convex. An optical axis region 26 and a periphery region 27 of the image-side surface 22 of the second lens element 20 are convex. Besides, both the object-side surface 21 and the image-side surface 22 of the second lens element 20 are aspherical surfaces, but it is not limited thereto.

The third lens element 30 has negative refracting power. An optical axis region 33 of the object-side surface 31 of the third lens element 30 is convex and a periphery region 34 of the object-side surface 31 of the third lens element 30 is concave. An optical axis region 36 of the image-side surface 32 of the third lens element 30 is concave and a periphery region 37 of the image-side surface 32 of the third lens element 30 is convex. Besides, both the object-side surface 31 and the image-side surface 32 of the third lens element 30 are aspherical surfaces, but it is not limited thereto.

The fourth lens element 40 has negative refracting power. An optical axis region 43 of the object-side surface 41 of the fourth lens element 40 is convex and a periphery region 44 of the object-side surface 41 of the fourth lens element 40 is concave. An optical axis region 46 and a periphery region 47 of the image-side surface 42 of the fourth lens element 40 are concave. Besides, both the object-side surface 41 and the image-side surface 42 of the fourth lens element 40 are aspherical surfaces, but it is not limited thereto. An optical axis region 46 or a periphery region 47 of the image-side surface 42 of the fourth lens element 40 is designed to be concave to be helpful to reduce the difference between the best focus planes of visible light and of infrared light.

The fifth lens element 50 has positive refracting power. An optical axis region 53 and a periphery region 54 of the object-side surface 51 of the fifth lens element 50 are concave. An optical axis region 56 of the image-side surface 52 of the fifth lens element 50 is convex and a periphery region 57 of the image-side surface 52 of the fifth lens element 50 is concave. Besides, both the object-side surface 51 and the image-side surface 52 of the fifth lens element 50 are aspherical surfaces, but it is not limited thereto. An optical axis region 53 or a periphery region 54 of the object-side surface 51 of the fifth lens element 50 is designed to be concave to be helpful to reduce the difference between the best focus planes of visible light and of infrared light.

The sixth lens element 60 has negative refracting power. An optical axis region 63 of the object-side surface 61 of the sixth lens element 60 is convex and a periphery region 64 of the object-side surface 61 of the sixth lens element 60 is concave. An optical axis region 66 of the image-side surface 62 of the sixth lens element 60 is concave and a periphery region 67 of the image-side surface 62 of the sixth lens element 60 is convex. Besides, both the object-side surface 61 and the image-side surface 62 of the sixth lens element 60 are aspherical surfaces, but it is not limited thereto.

In the optical imaging lens element 1 of the present invention, from the first lens element 10 to the sixth lens element 60, all the 12 surfaces, such as the object-side surfaces 11/21/31/41/51/61 and the image-side surfaces 12/22/32/42/52/62 are aspherical surfaces, but they are not limited thereto. If a surface is aspherical, these aspheric coefficients are defined according to the following formula:

$$Z ( Y ) = \frac{{Y}^{2}}{R} / ( 1 + \sqrt{1 - ( 1 + K ) \frac{{Y}^{2}}{{R}^{2}}} ) + {\sum }_{i = 1}^{n} {a}_{2 i} \times {Y}^{2 i}$$

In which:
Y represents a vertical distance from a point on the aspherical surface to the optical axis I;
Z represents the depth of an aspherical surface (the perpendicular distance between the point of the aspherical surface at a distance Y from the optical axis I and the tangent plane of the vertex on the optical axis I of the aspherical surface);
R represents the radius of curvature of the lens element surface close to the optical axis I;
K is a conic constant; and
a₂ᵢ is the aspheric coefficient of the 2i^{th} order.

In the present invention, the wavelength 555 nm may be selected as the main reference wavelength in the visible light spectrum (450 nm to 650 nm) and for the reference of the measurement of the focus shift, and the wavelength 850 nm may be selected as the main reference wavelength in the infrared light spectrum (800 nm to 950 nm) and for the reference of the measurement of the focus shift.

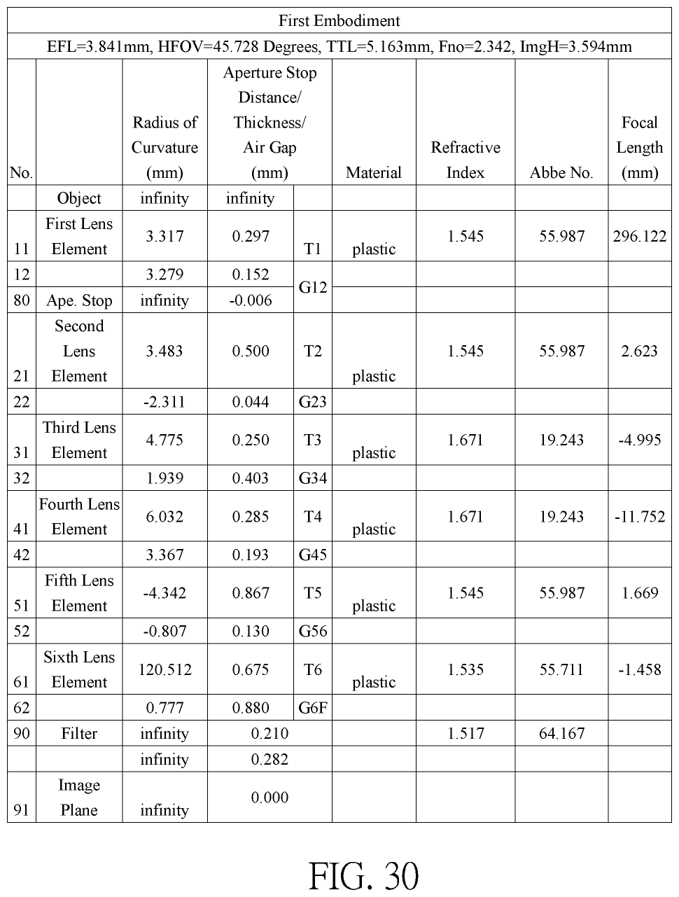

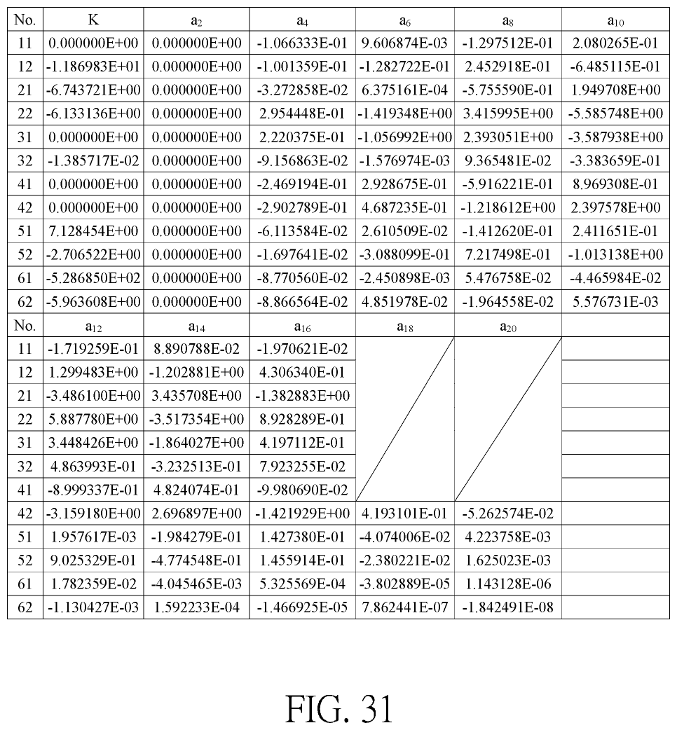

The optical data of the first embodiment of the optical imaging lens 1 are shown in FIG. 30 while the aspheric surface data are shown in FIG. 31. In the present embodiments of the optical imaging lens, the f-number of the entire optical imaging lens is Fno, EFL is the effective focal length, HFOV stands for the half field of view of the entire optical imaging lens, and the unit for the image height (ImgH), the radius of curvature, the thickness and the focal length is in millimeters (mm). In this embodiment, EFL=3.841 mm; HFOV=45.728 degrees; TTL=5.163 mm; Fno=2.342; ImgH=3.594 mm.

### Second Embodiment

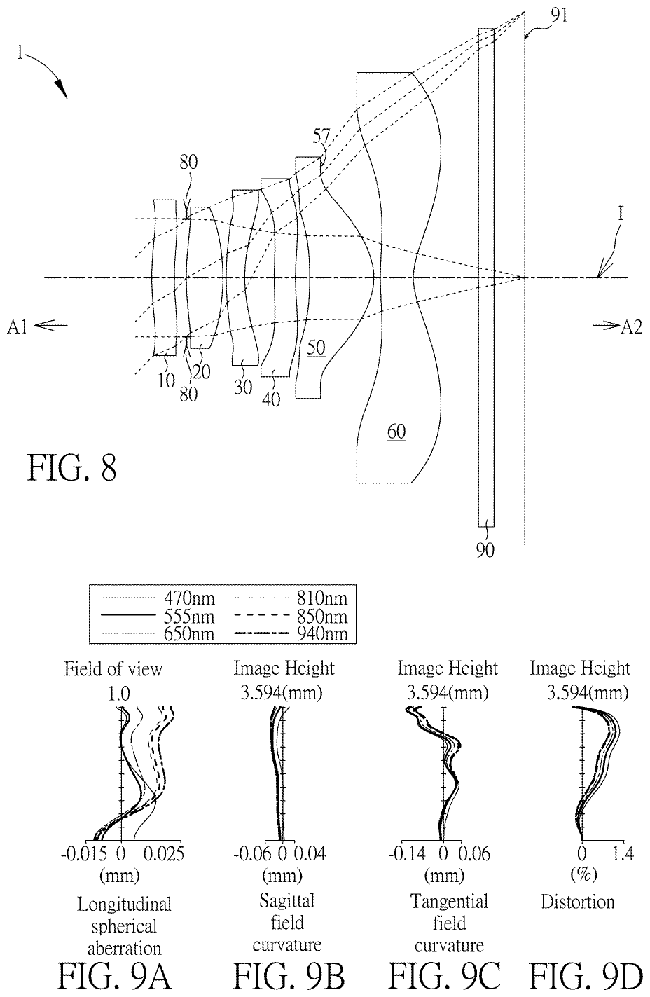

Please refer to FIG. 8 which illustrates the second embodiment of the optical imaging lens 1 of the present invention. It is noted that from the second embodiment to the following embodiments, in order to simplify the figures, only the components different from what the first embodiment has, and the basic lens elements will be labeled in figures. Other components that are the same as what the first embodiment has, such as a convex surface or a concave surface, are omitted in the following embodiments. Please refer to FIG. 9A for the longitudinal spherical aberration on the image plane 91 of the second embodiment, please refer to FIG. 9B for the field curvature aberration on the sagittal direction, please refer to FIG. 9C for the field curvature aberration on the tangential direction, and please refer to FIG. 9D for the distortion aberration. The components in this embodiment are similar to those in the first embodiment, but the optical data such as the refracting power, the radius of curvature, the lens thickness, the aspheric surface or the back focal length in this embodiment are different from the optical data in the first embodiment. Besides, in this embodiment, the periphery region 57 of the image-side surface 52 of the fifth lens element 50 is convex. Considering the curvature of the entire image-side surface 52 of the fifth lens element 50, the periphery region 57 of the image-side surface 52 of the fifth lens element 50 is designed to be convex to effectively increase the production yield.

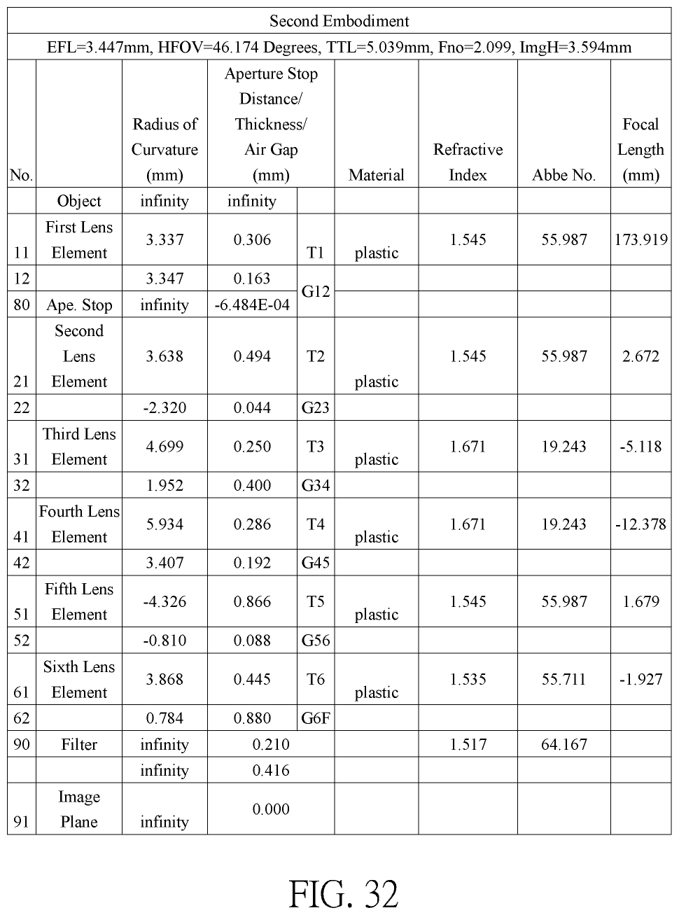

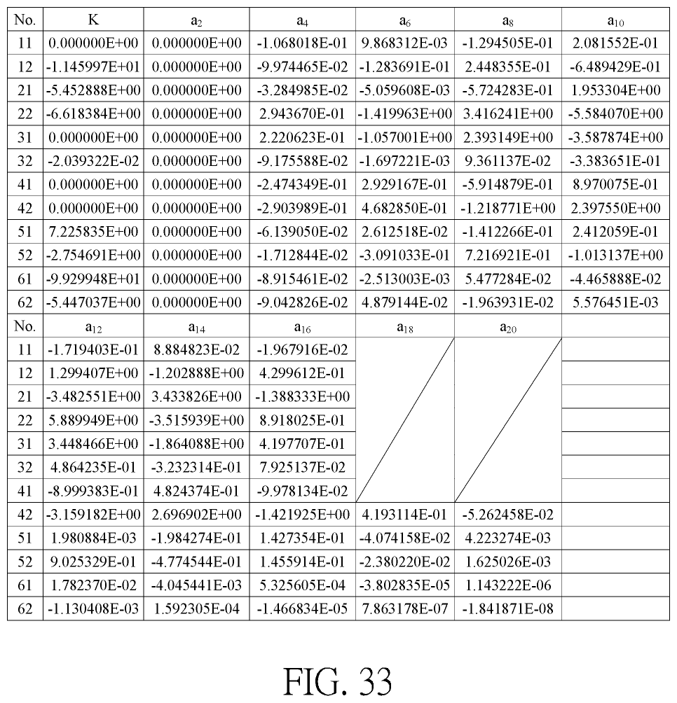

The optical data of the second embodiment of the optical imaging lens are shown in FIG. 32 while the aspheric surface data are shown in FIG. 33. In this embodiment, EFL=3.447 mm; HFOV=46.174 degrees; TTL=5.039 mm; Fno=2.099; ImgH=3.594 mm. In particular, 1) TTL of the optical imaging lens in this embodiment is shorter than that of the optical imaging lens in the first embodiment, 2) HFOV of the optical imaging lens in this embodiment is larger than that of the optical imaging lens in the first embodiment, 3) the field curvature aberration on the tangential direction of the optical imaging lens in this embodiment is better than that of the optical imaging lens in the first embodiment, and 4) the distortion aberration of the optical imaging lens in this embodiment is better than that of the optical imaging lens in the first embodiment.

### Third Embodiment

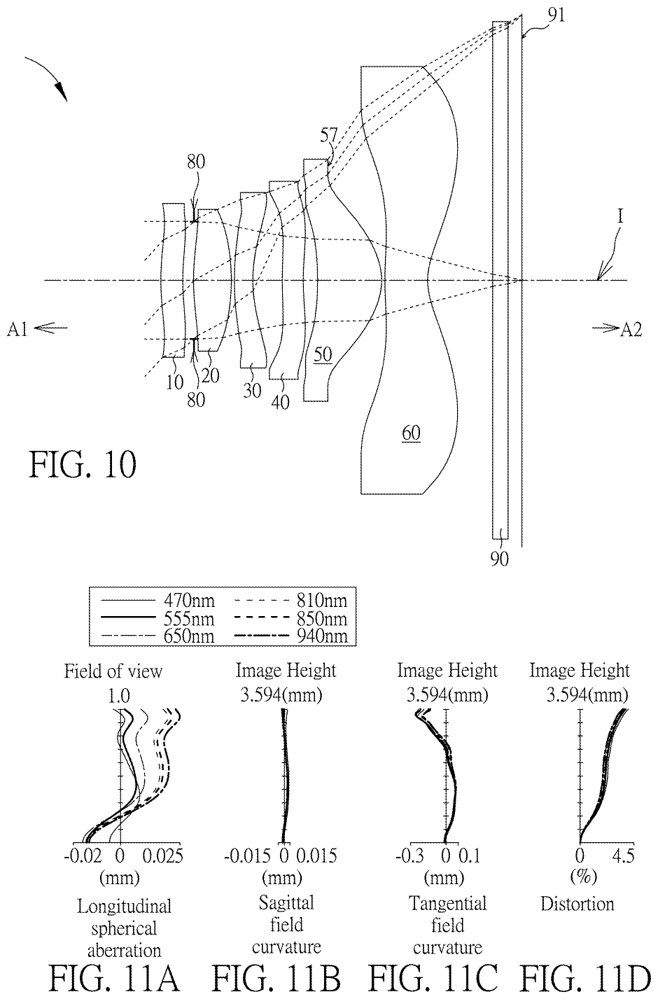

Please refer to FIG. 10 which illustrates the third embodiment of the optical imaging lens 1 of the present invention. Please refer to FIG. 11A for the longitudinal spherical aberration on the image plane 91 of the third embodiment; please refer to FIG. 11B for the field curvature aberration on the sagittal direction; please refer to FIG. 11C for the field curvature aberration on the tangential direction; and please refer to FIG. 11D for the distortion aberration. The components in this embodiment are similar to those in the first embodiment, but the optical data such as the refracting power, the radius of curvature, the lens thickness, the aspheric surface or the back focal length in this embodiment are different from the optical data in the first embodiment. Besides, in this embodiment, the periphery region 57 of the image-side surface 52 of the fifth lens element 50 is convex.

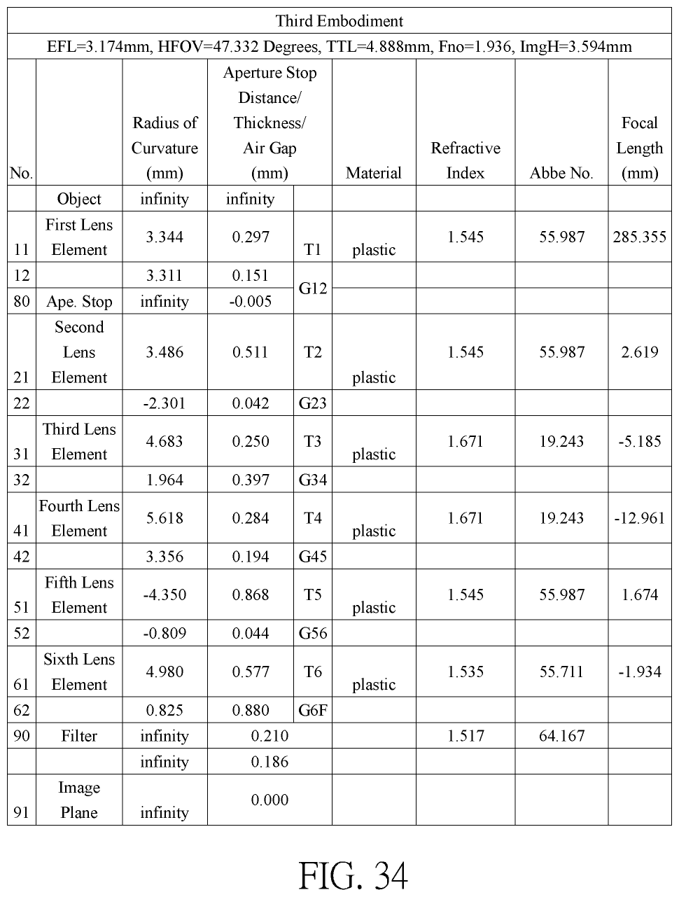

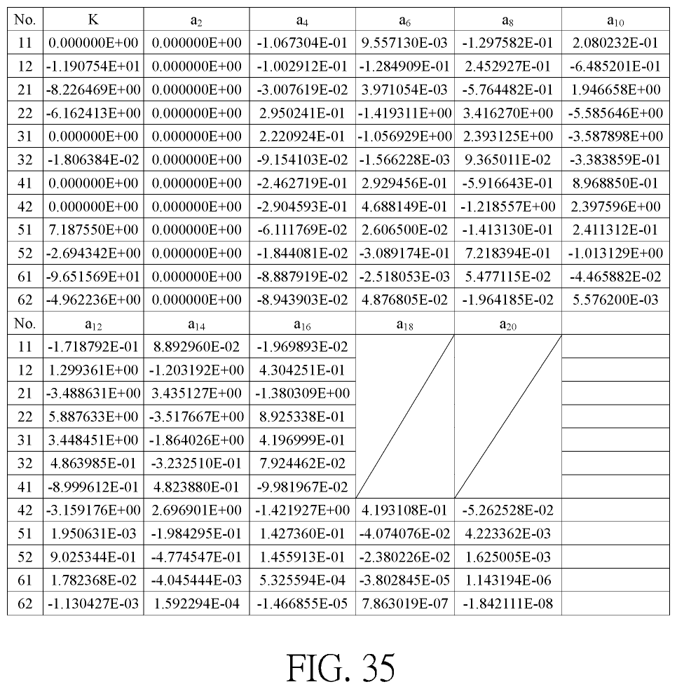

The optical data of the third embodiment of the optical imaging lens are shown in FIG. 34 while the aspheric surface data are shown in FIG. 35. In this embodiment, EFL=3.174 mm; HFOV=47.332 degrees; TTL=4.888 mm; Fno=1.936; ImgH=3.594 mm. In particular, 1) TTL of the optical imaging lens in this embodiment is shorter than that of the optical imaging lens in the first embodiment, 2) HFOV of the optical imaging lens in this embodiment is larger than that of the optical imaging lens in the first embodiment, 3) the field curvature aberration on the sagittal direction of the optical imaging lens in this embodiment is better than that of the optical imaging lens in the first embodiment, and 4) the distortion aberration of the optical imaging lens in this embodiment is better than that of the optical imaging lens in the first embodiment.

### Fourth Embodiment

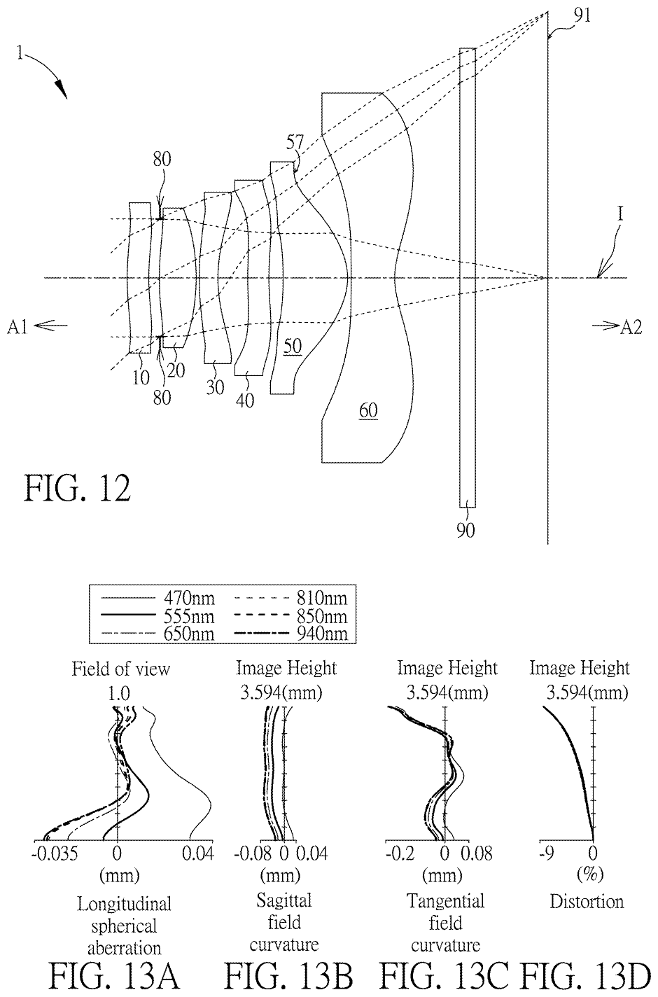

Please refer to FIG. 12 which illustrates the fourth embodiment of the optical imaging lens 1 of the present invention. Please refer to FIG. 13A for the longitudinal spherical aberration on the image plane 91 of the fourth embodiment; please refer to FIG. 13B for the field curvature aberration on the sagittal direction; please refer to FIG. 13C for the field curvature aberration on the tangential direction; and please refer to FIG. 13D for the distortion aberration. The components in this embodiment are similar to those in the first embodiment, but the optical data such as the refracting power, the radius of curvature, the lens thickness, the aspheric surface or the back focal length in this embodiment are different from the optical data in the first embodiment. Besides, in this embodiment, the first lens element 10 has negative refracting power and the periphery region 57 of the image-side surface 52 of the fifth lens element 50 is convex.

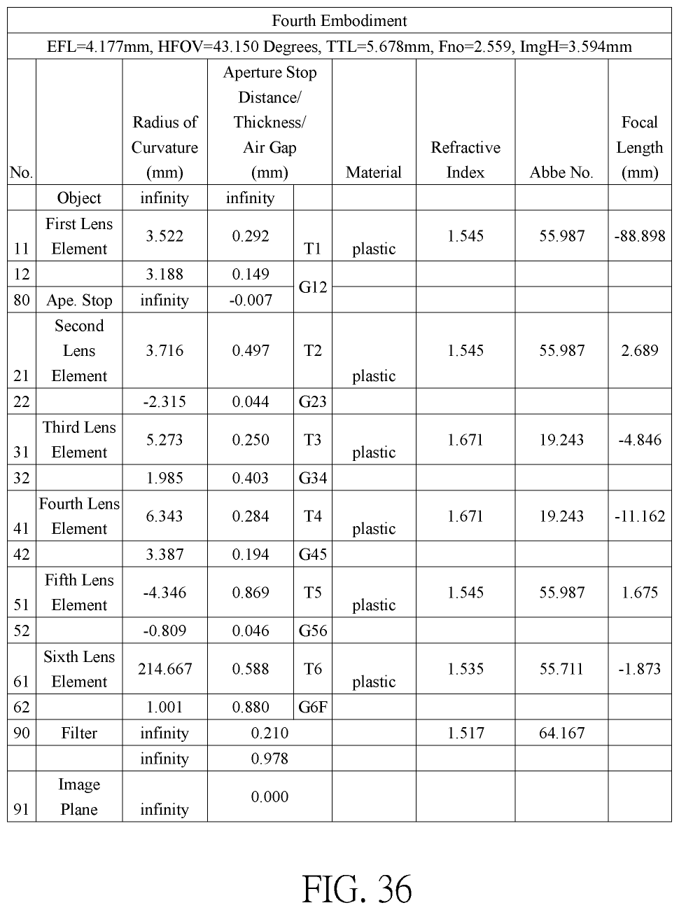

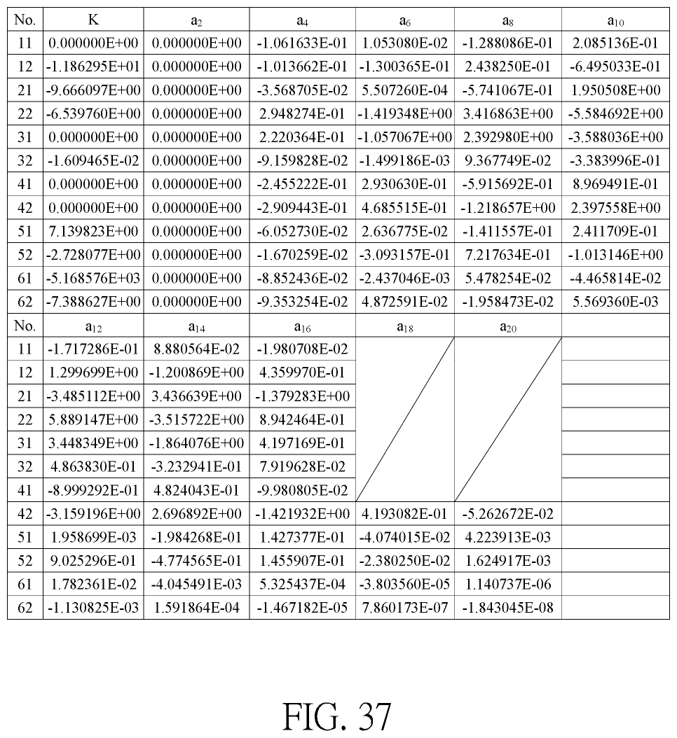

The optical data of the fourth embodiment of the optical imaging lens are shown in FIG. 36 while the aspheric surface data are shown in FIG. 37. In this embodiment, EFL=4.177 mm; HFOV=43.150 degrees; TTL=5.678 mm; Fno=2.559; ImgH=3.594 mm.

### Fifth Embodiment

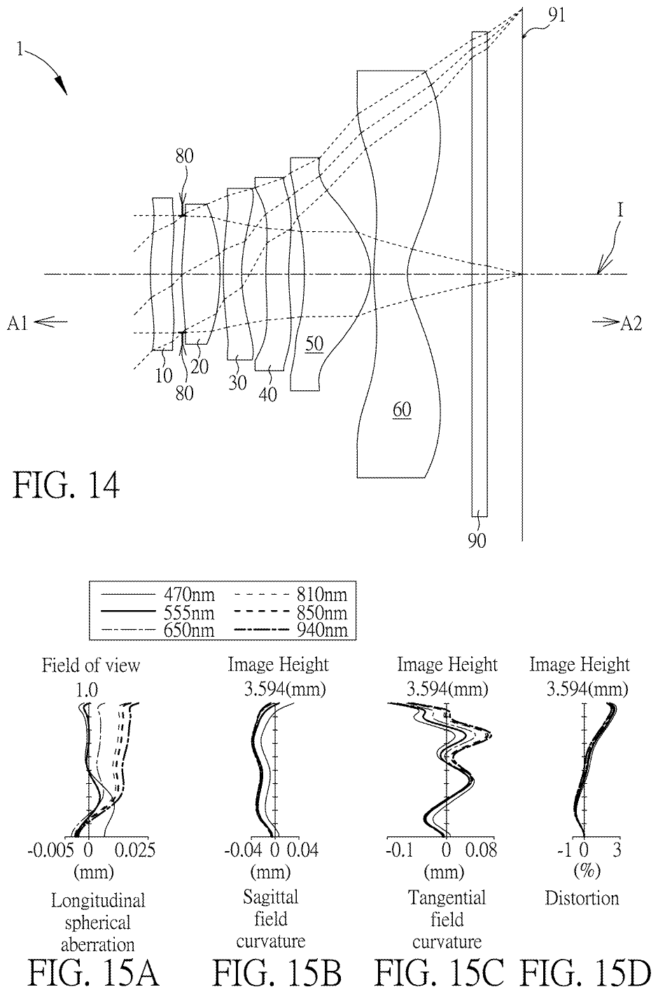

Please refer to FIG. 14 which illustrates the fifth embodiment of the optical imaging lens 1 of the present invention. Please refer to FIG. 15A for the longitudinal spherical aberration on the image plane 91 of the fifth embodiment; please refer to FIG. 15B for the field curvature aberration on the sagittal direction; please refer to FIG. 15C for the field curvature aberration on the tangential direction, and please refer to FIG. 15D for the distortion aberration. The components in this embodiment are similar to those in the first embodiment, but the optical data such as the refracting power, the radius of curvature, the lens thickness, the aspheric surface or the back focal length in this embodiment are different from the optical data in the first embodiment.

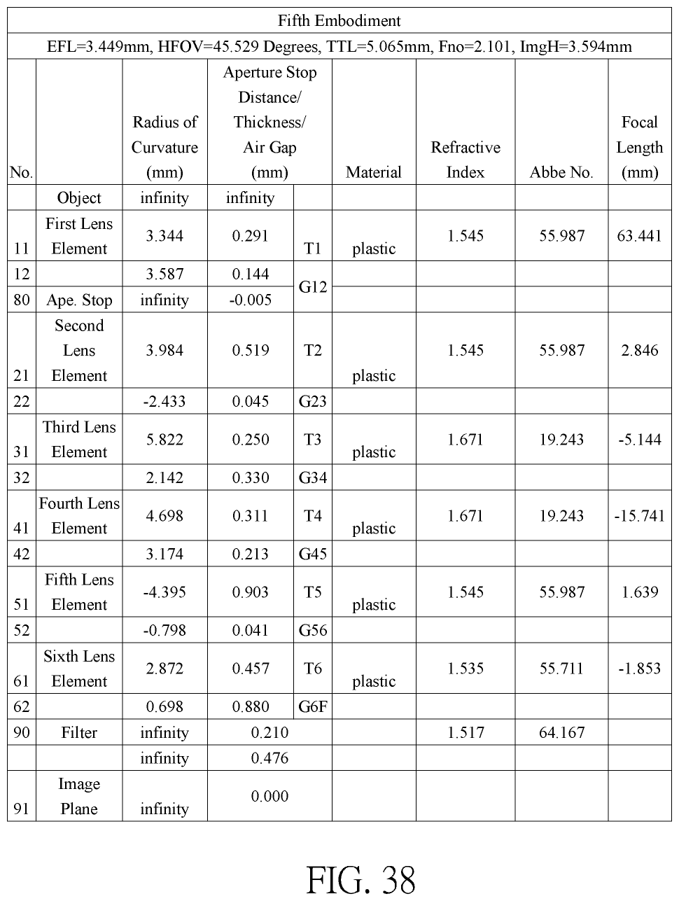

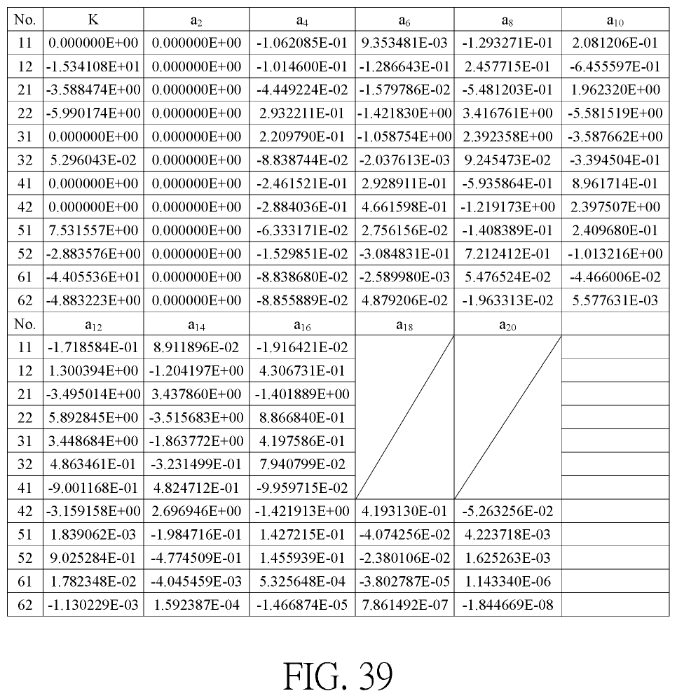

The optical data of the fifth embodiment of the optical imaging lens are shown in FIG. 38 while the aspheric surface data are shown in FIG. 39. In this embodiment, EFL=3.449 mm; HFOV=45.529 degrees; TTL=5.065 mm; Fno=2.101; ImgH=3.594 mm. In particular, 1) TTL of the optical imaging lens in this embodiment is shorter than that of the optical imaging lens in the first embodiment, 2) the longitudinal spherical aberration of the optical imaging lens in this embodiment is better than that of the optical imaging lens in the first embodiment, 3) the field curvature aberration on the sagittal direction of the optical imaging lens in this embodiment is better than that of the optical imaging lens in the first embodiment, 4) the field curvature aberration on the tangential direction of the optical imaging lens in this embodiment is better than that of the optical imaging lens in the first embodiment, and 5) the distortion aberration of the optical imaging lens in this embodiment is better than that of the optical imaging lens in the first embodiment

### Sixth Embodiment

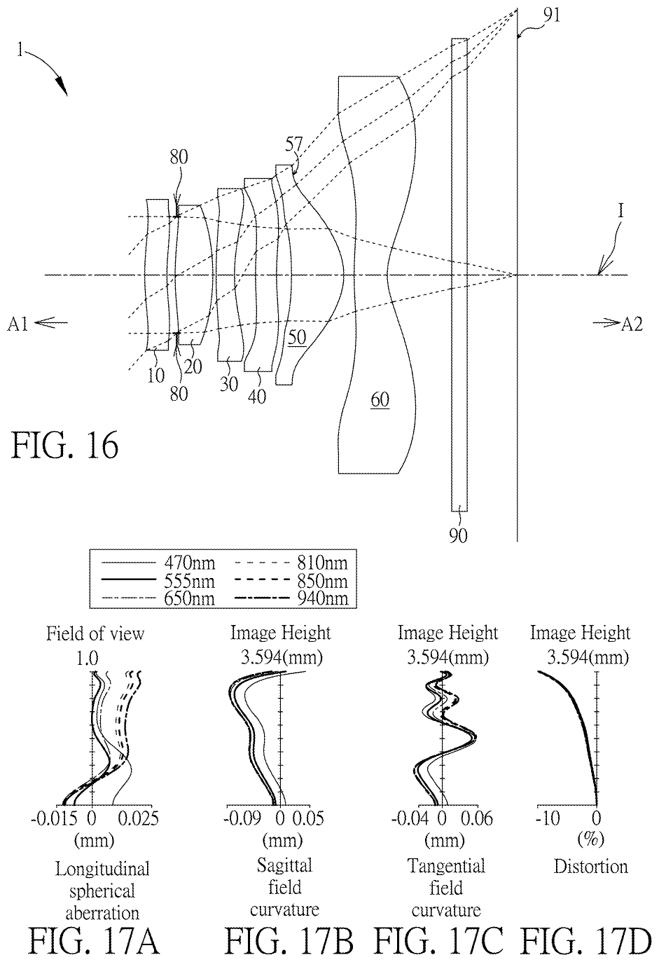

Please refer to FIG. 16 which illustrates the sixth embodiment of the optical imaging lens 1 of the present invention. Please refer to FIG. 17A for the longitudinal spherical aberration on the image plane 91 of the sixth embodiment; please refer to FIG. 17B for the field curvature aberration on the sagittal direction; please refer to FIG. 17C for the field curvature aberration on the tangential direction, and please refer to FIG. 17D for the distortion aberration. The components in this embodiment are similar to those in the first embodiment, but the optical data such as the refracting power, the radius of curvature, the lens thickness, the aspheric surface or the back focal length in this embodiment are different from the optical data in the first embodiment. Besides, in this embodiment, the first lens element 10 has negative refracting power, and the periphery region 57 of the image-side surface 52 of the fifth lens element 50 is convex.

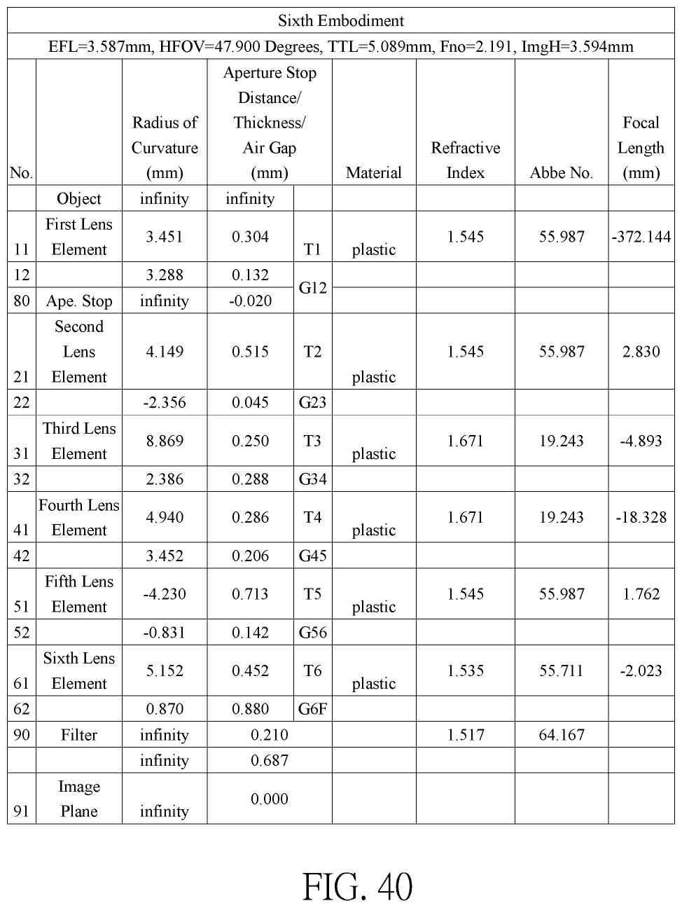

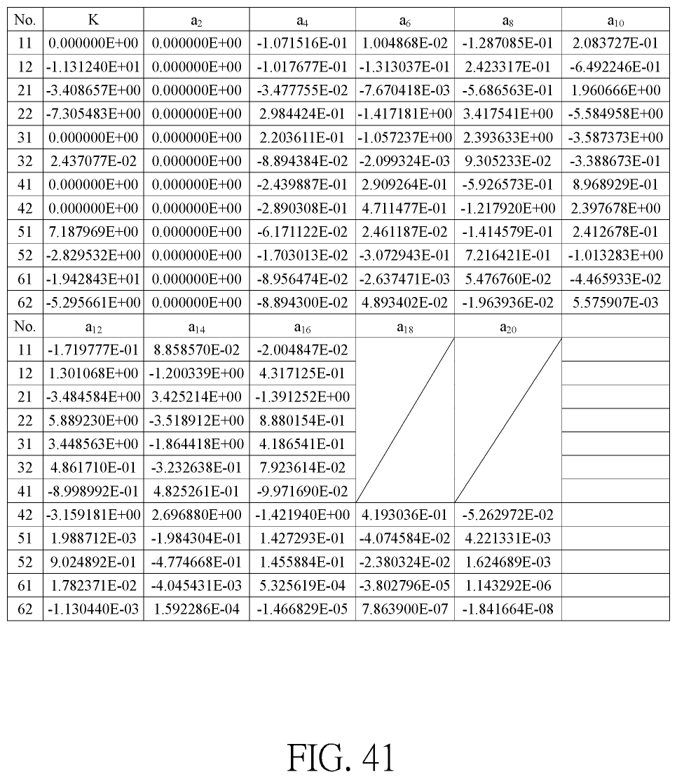

The optical data of the sixth embodiment of the optical imaging lens are shown in FIG. 40 while the aspheric surface data are shown in FIG. 41. In this embodiment, EFL=3.587 mm; HFOV=47.900 degrees; TTL=5.089 mm; Fno=2.191; ImgH=3.594 mm. In particular, 1) TTL of the optical imaging lens in this embodiment is shorter than that of the optical imaging lens in the first embodiment, 2) HFOV of the optical imaging lens in this embodiment is larger than that of the optical imaging lens in the first embodiment, and 3) the field curvature aberration on the tangential direction of the optical imaging lens in this embodiment is better than that of the optical imaging lens in the first embodiment.

### Seventh Embodiment

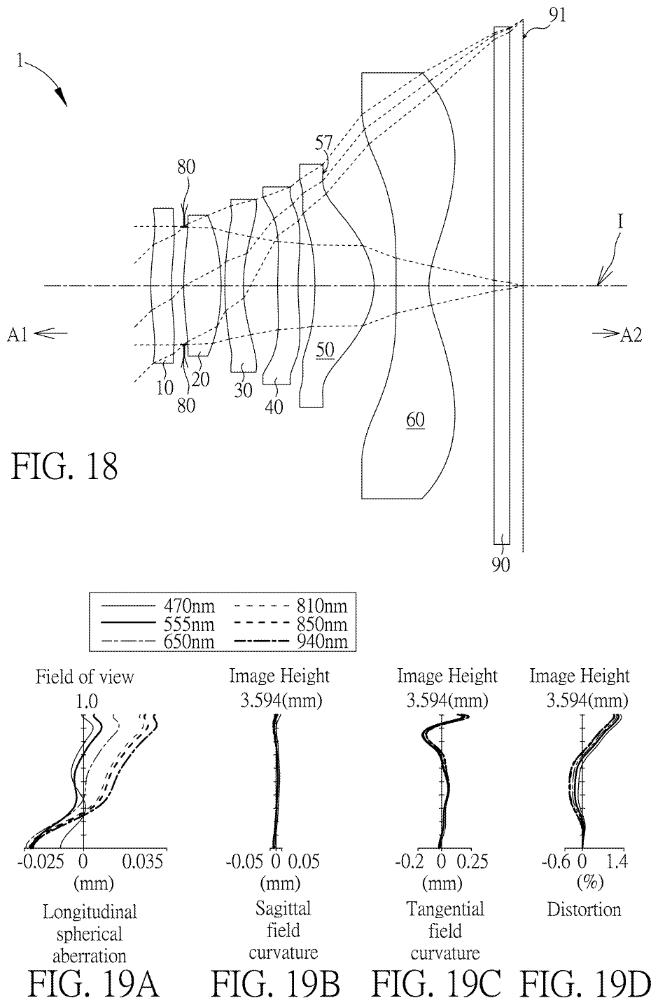

Please refer to FIG. 18 which illustrates the seventh embodiment of the optical imaging lens 1 of the present invention. Please refer to FIG. 19A for the longitudinal spherical aberration on the image plane 91 of the seventh embodiment; please refer to FIG. 19B for the field curvature aberration on the sagittal direction; please refer to FIG. 19C for the field curvature aberration on the tangential direction, and please refer to FIG. 19D for the distortion aberration. The components in this embodiment are similar to those in the first embodiment, but the optical data such as the refracting power, the radius of curvature, the lens thickness, the aspheric surface or the back focal length in this embodiment are different from the optical data in the first embodiment. Besides, in this embodiment, the periphery region 57 of the image-side surface 52 of the fifth lens element 50 is convex.

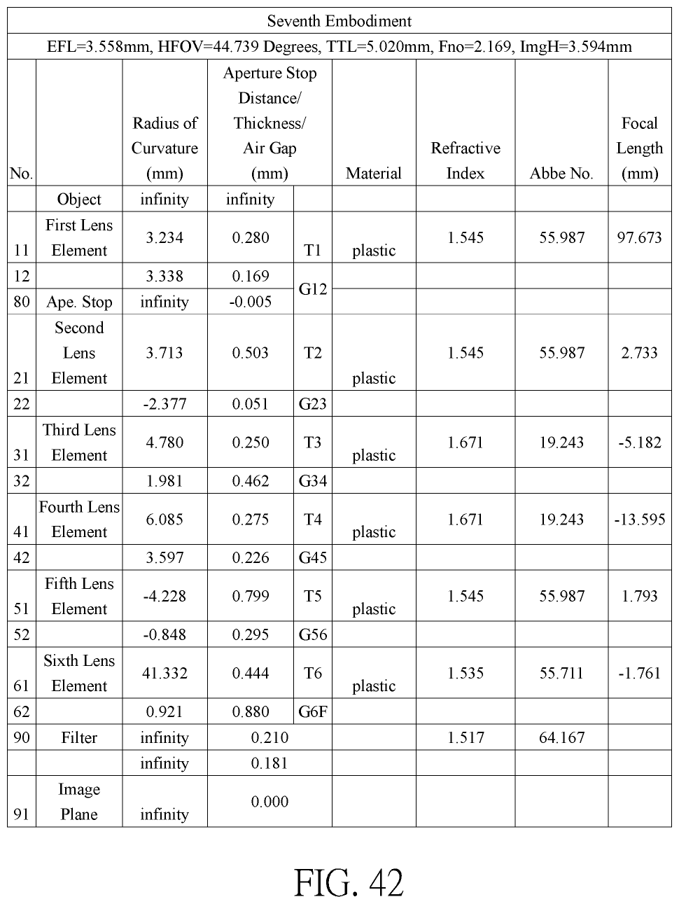

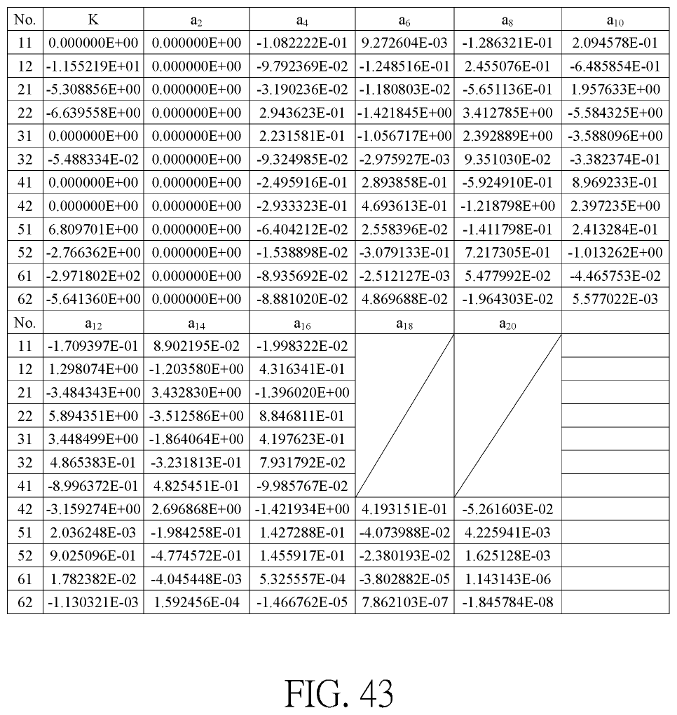

The optical data of the seventh embodiment of the optical imaging lens are shown in FIG. 42 while the aspheric surface data are shown in FIG. 43. In this embodiment, EFL=3.558 mm; HFOV=44.739 degrees; TTL=5.020 mm; Fno=2.169; ImgH=3.594 mm. In particular, 1) TTL of the optical imaging lens in this embodiment is shorter than that of the optical imaging lens in the first embodiment, 2) the field curvature aberration on the sagittal direction of the optical imaging lens in this embodiment is better than that of the optical imaging lens in the first embodiment, and 3) the distortion aberration of the optical imaging lens in this embodiment is better than that of the optical imaging lens in the first embodiment.

### Eighth Embodiment

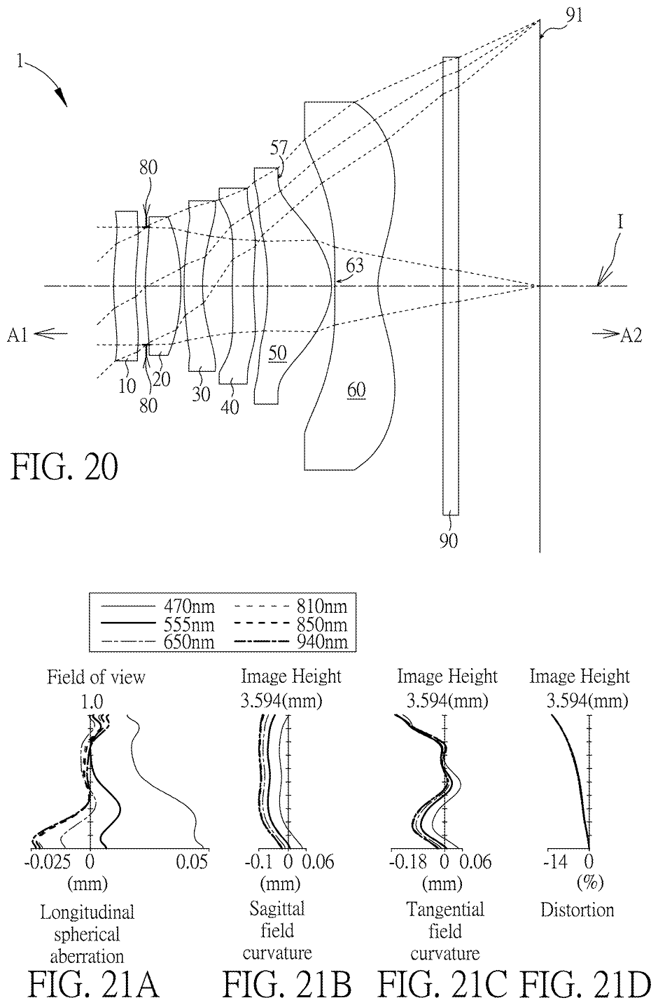

Please refer to FIG. 20 which illustrates the eighth embodiment of the optical imaging lens 1 of the present invention. Please refer to FIG. 21A for the longitudinal spherical aberration on the image plane 91 of the eighth embodiment; please refer to FIG. 21B for the field curvature aberration on the sagittal direction; please refer to FIG. 21C for the field curvature aberration on the tangential direction, and please refer to FIG. 21D for the distortion aberration. The components in this embodiment are similar to those in the first embodiment, but the optical data such as the refracting power, the radius of curvature, the lens thickness, the aspheric surface or the back focal length in this embodiment are different from the optical data in the first embodiment. Besides, in this embodiment, the first lens element 10 has negative refracting power, the periphery region 57 of the image-side surface 52 of the fifth lens element 50 is convex, and the optical axis region 63 of the object-side surface 61 of the sixth lens element 60 is concave. Considering the curvature of the entire object-side surface 61 of the sixth lens element 60, the optical axis region 63 of the object-side surface 61 of the sixth lens element 60 is designed to be concave to effectively increase the production yield.

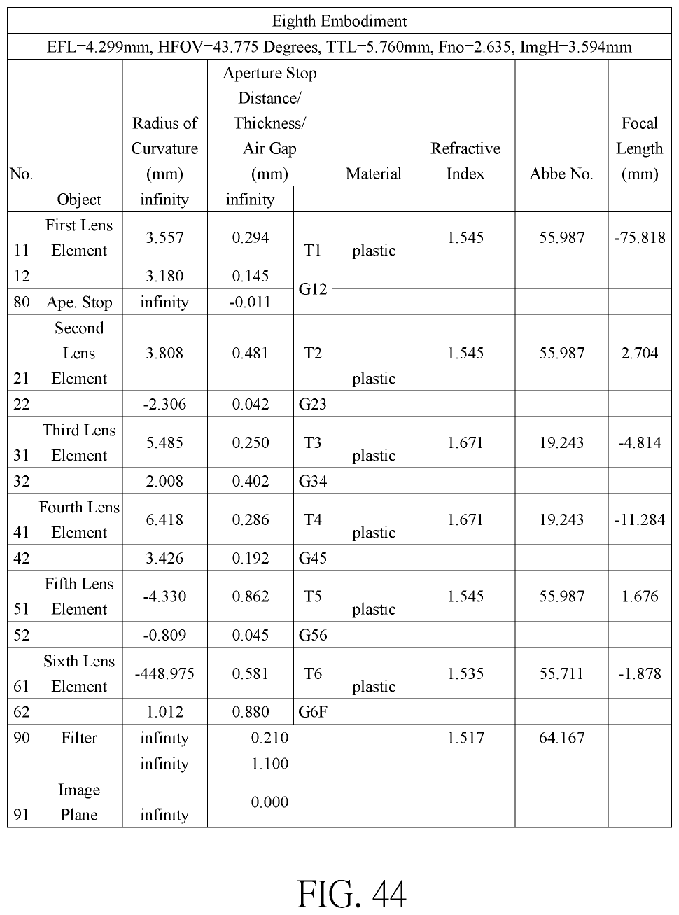

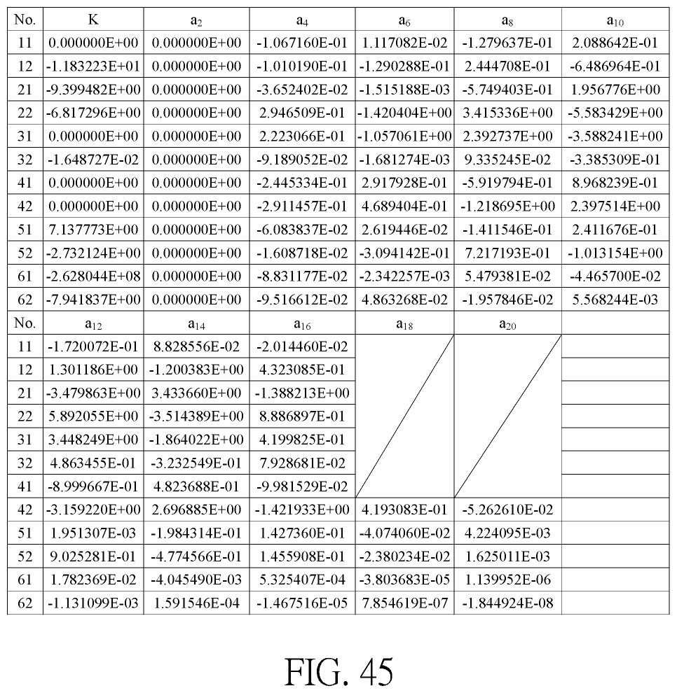

The optical data of the eighth embodiment of the optical imaging lens are shown in FIG. 44 while the aspheric surface data are shown in FIG. 45. In this embodiment, EFL=4.299 mm; HFOV=43.775 degrees; TTL=5.760 mm; Fno=2.635; ImgH=3.594 mm.

### Ninth Embodiment

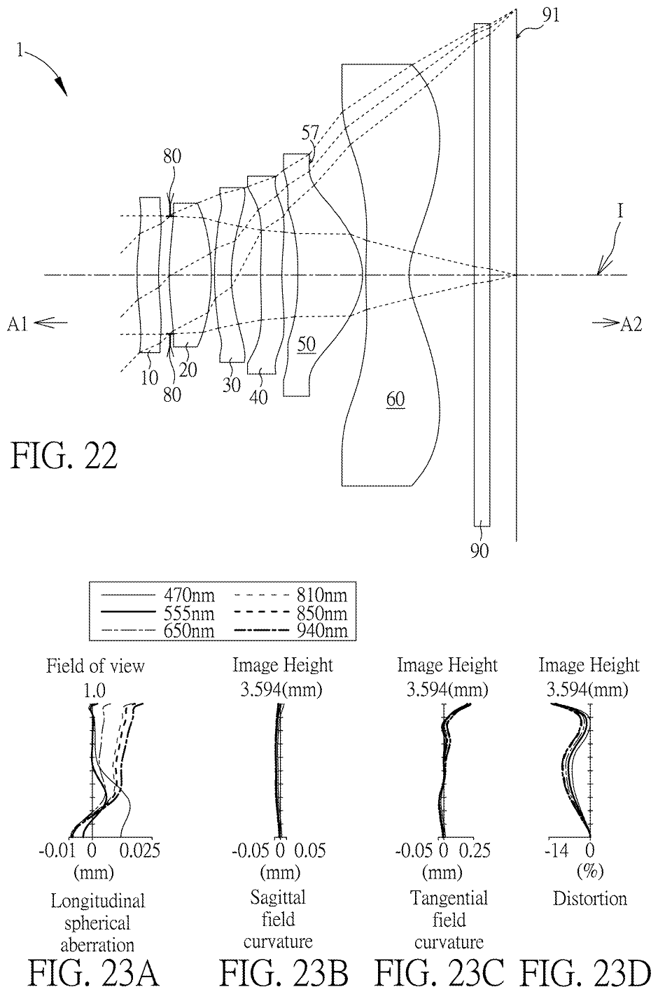

Please refer to FIG. 22 which illustrates the ninth embodiment of the optical imaging lens 1 of the present invention. Please refer to FIG. 23A for the longitudinal spherical aberration on the image plane 91 of the ninth embodiment; please refer to FIG. 23B for the field curvature aberration on the sagittal direction; please refer to FIG. 23C for the field curvature aberration on the tangential direction, and please refer to FIG. 23D for the distortion aberration. The components in this embodiment are similar to those in the first embodiment, but the optical data such as the refracting power, the radius of curvature, the lens thickness, the aspheric surface or the back focal length in this embodiment are different from the optical data in the first embodiment. Besides, in this embodiment, the periphery region 57 of the image-side surface 52 of the fifth lens element 50 is convex.

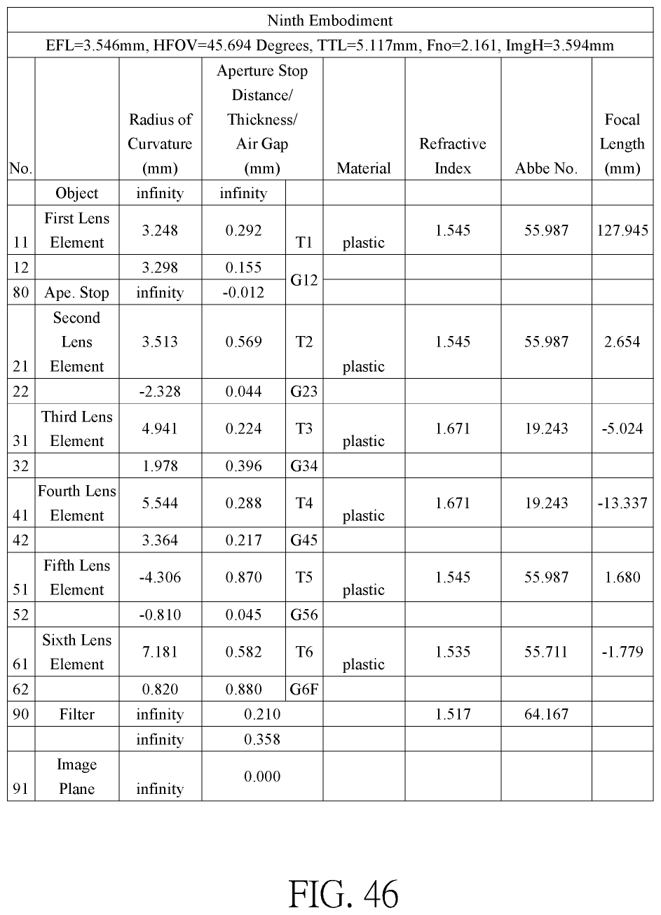

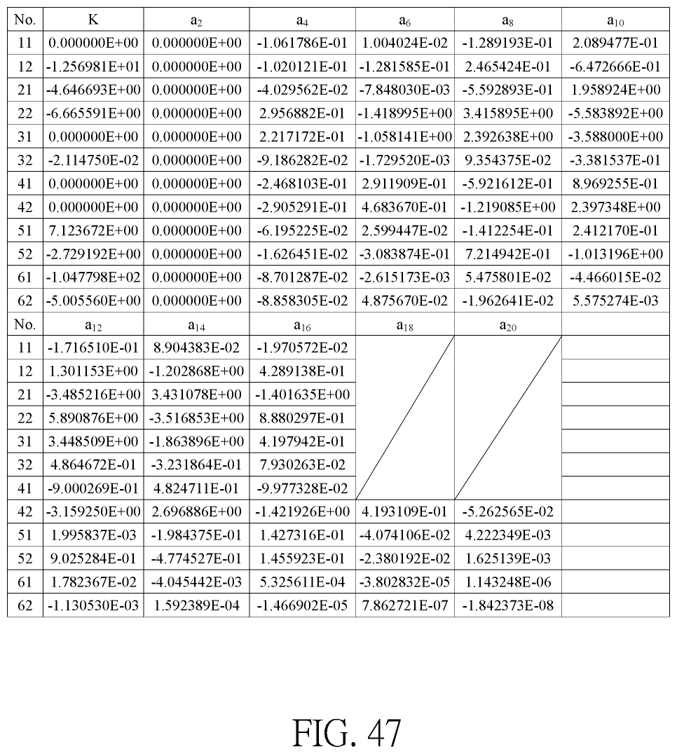

The optical data of the ninth embodiment of the optical imaging lens are shown in FIG. 46 while the aspheric surface data are shown in FIG. 47. In this embodiment, EFL=3.546 mm; HFOV=45.694 degrees; TTL=5.117 mm; Fno=2.161; ImgH=3.594 mm. In particular, TTL of the optical imaging lens in this embodiment is shorter than that of the optical imaging lens in the first embodiment.

### Tenth Embodiment

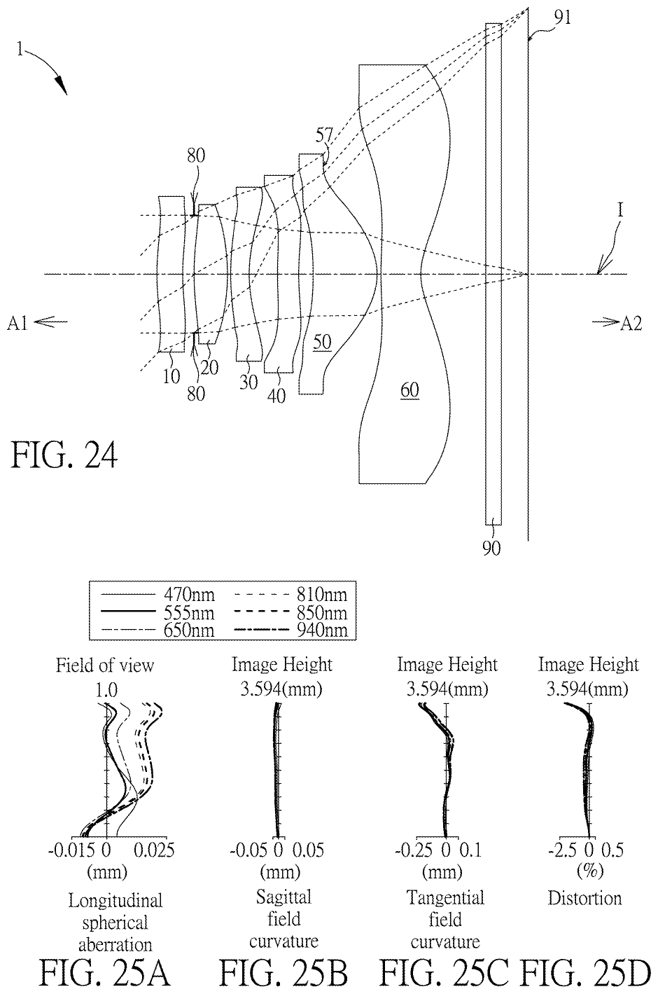

Please refer to FIG. 24 which illustrates the tenth embodiment of the optical imaging lens 1 of the present invention. Please refer to FIG. 25A for the longitudinal spherical aberration on the image plane 91 of the tenth embodiment; please refer to FIG. 25B for the field curvature aberration on the sagittal direction; please refer to FIG. 25C for the field curvature aberration on the tangential direction, and please refer to FIG. 25D for the distortion aberration. The components in this embodiment are similar to those in the first embodiment, but the optical data such as the refracting power, the radius of curvature, the lens thickness, the aspheric surface or the back focal length in this embodiment are different from the optical data in the first embodiment. Besides, in this embodiment, the periphery region 57 of the image-side surface 52 of the fifth lens element 50 is convex.

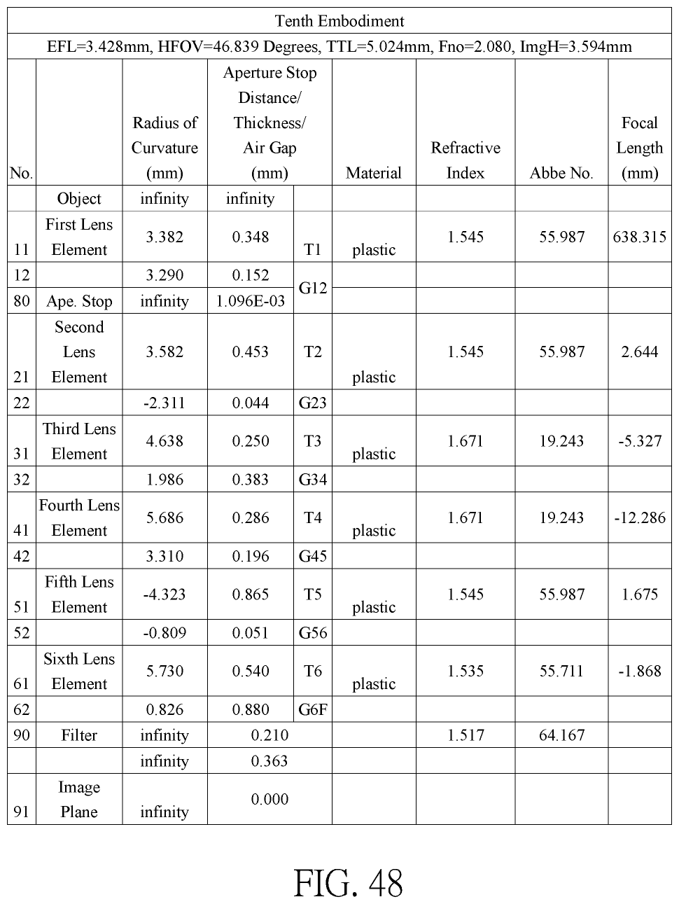

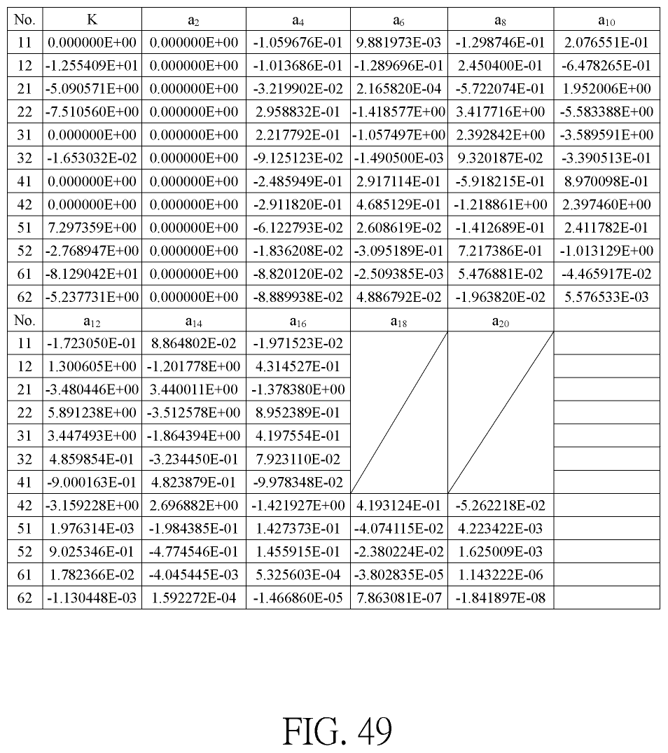

The optical data of the tenth embodiment of the optical imaging lens are shown in FIG. 48 while the aspheric surface data are shown in FIG. 49. In this embodiment, EFL=3.428 mm; HFOV=46.839 degrees; TTL=5.024 mm; Fno=2.080; ImgH=3.594 mm. In particular, 1) TTL of the optical imaging lens in this embodiment is shorter than that of the optical imaging lens in the first embodiment, 2) HFOV of the optical imaging lens in this embodiment is larger than that of the optical imaging lens in the first embodiment, and 3) the distortion aberration of the optical imaging lens in this embodiment is better than that of the optical imaging lens in the first embodiment.

### Eleventh Embodiment

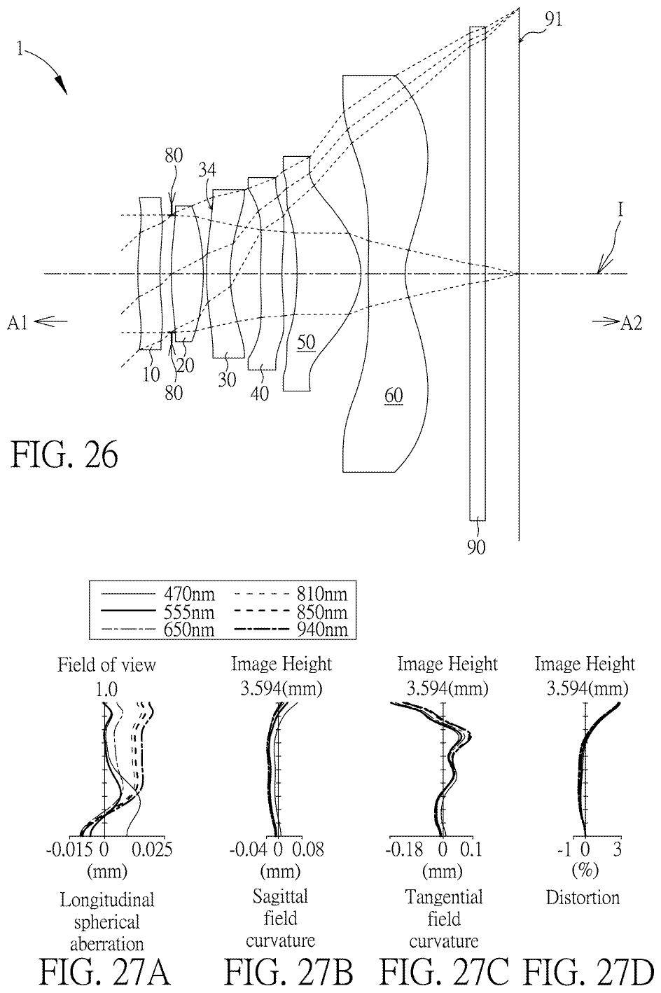

Please refer to FIG. 26 which illustrates the eleventh embodiment of the optical imaging lens 1 of the present invention. Please refer to FIG. 27A for the longitudinal spherical aberration on the image plane 91 of the eleventh embodiment; please refer to FIG. 27B for the field curvature aberration on the sagittal direction; please refer to FIG. 27C for the field curvature aberration on the tangential direction, and please refer to FIG. 27D for the distortion aberration. The components in this embodiment are similar to those in the first embodiment, but the optical data such as the refracting power, the radius of curvature, the lens thickness, the aspheric surface or the back focal length in this embodiment are different from the optical data in the first embodiment. Besides, in this embodiment, the periphery region 34 of the object-side surface 31 of the third lens element 30 is convex. Considering the curvature of the entire object-side surface 31 of the third lens element 30, the periphery region 34 of the object-side surface 31 of the third lens element 30 is designed to be convex to effectively increase the production yield.

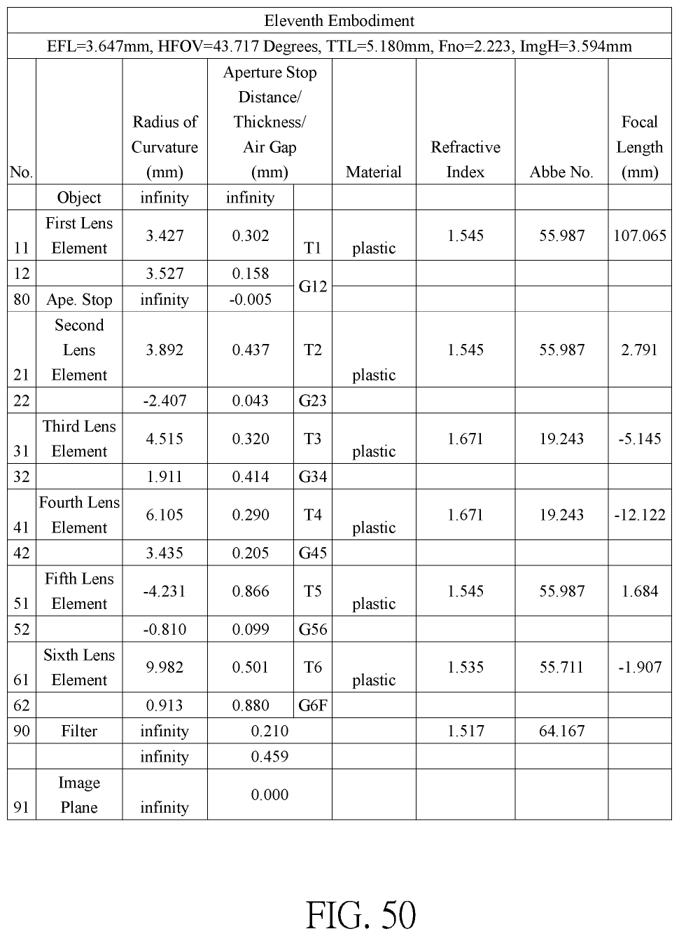

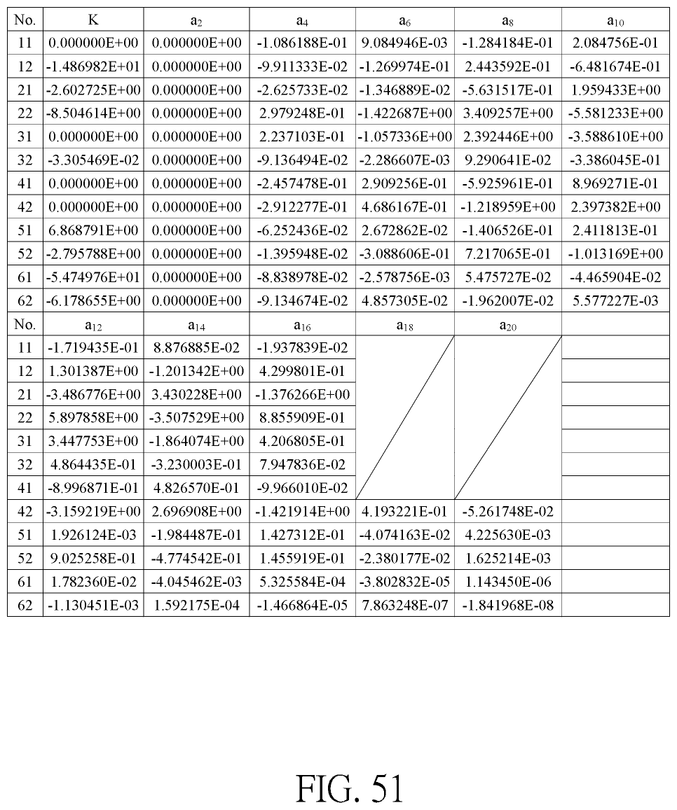

The optical data of the eleventh embodiment of the optical imaging lens are shown in FIG. 50 while the aspheric surface data are shown in FIG. 51. In this embodiment, EFL=3.647 mm; HFOV=43.717 degrees; TTL=5.180 mm; Fno=2.223; ImgH=3.594 mm. In particular, the distortion aberration of the optical imaging lens in this embodiment is better than that of the optical imaging lens in the first embodiment.

### Twelfth Embodiment

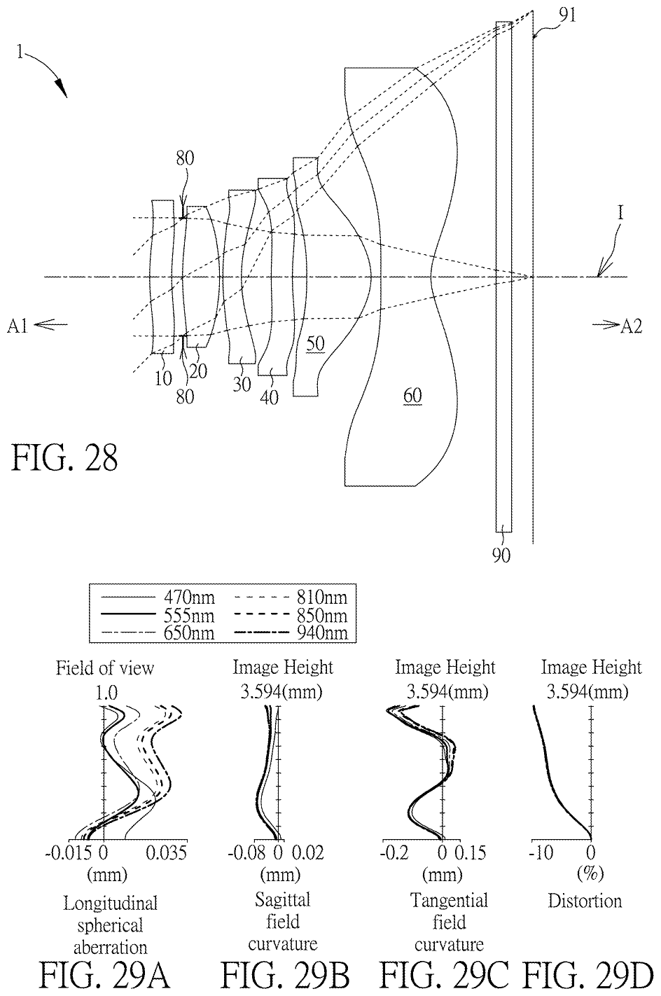

Please refer to FIG. 28 which illustrates the twelfth embodiment of the optical imaging lens 1 of the present invention. Please refer to FIG. 29A for the longitudinal spherical aberration on the image plane 91 of the twelfth embodiment; please refer to FIG. 29B for the field curvature aberration on the sagittal direction; please refer to FIG. 29C for the field curvature aberration on the tangential direction, and please refer to FIG. 29D for the distortion aberration. The components in this embodiment are similar to those in the first embodiment, but the optical data such as the refracting power, the radius of curvature, the lens thickness, the aspheric surface or the back focal length in this embodiment are different from the optical data in the first embodiment.

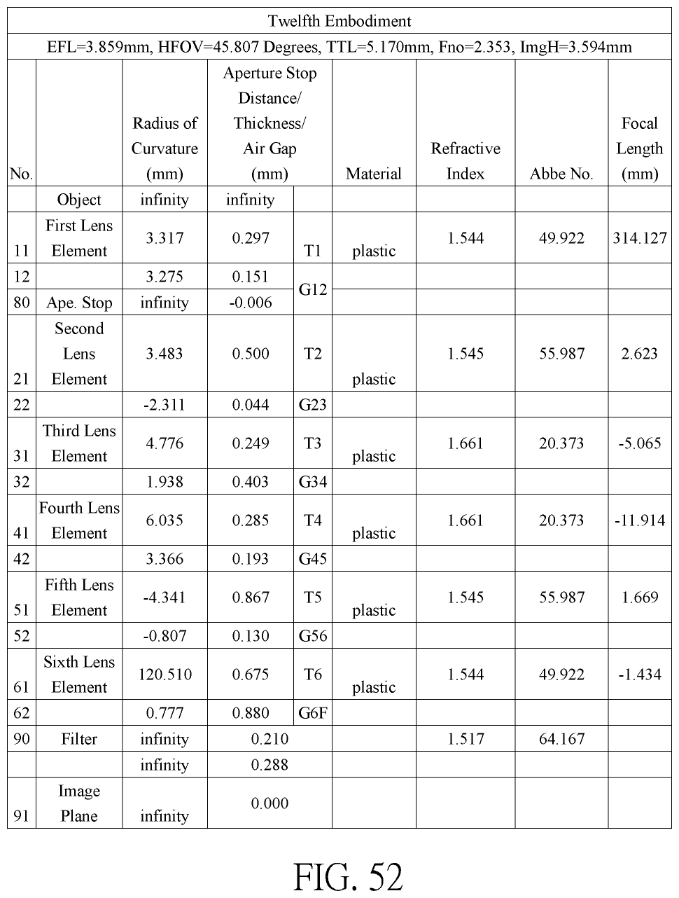

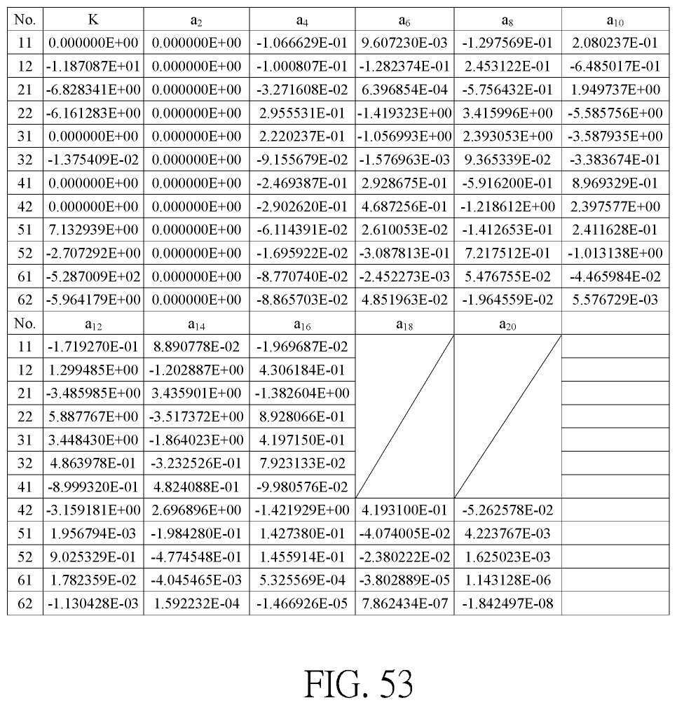

The optical data of the twelfth embodiment of the optical imaging lens are shown in FIG. 52 while the aspheric surface data are shown in FIG. 53. In this embodiment, EFL=3.859 mm; HFOV=45.807 degrees; TTL=5.170 mm; Fno=2.353; ImgH=3.594 mm. In particular, HFOV of the optical imaging lens in this embodiment is larger than that of the optical imaging lens in the first embodiment.

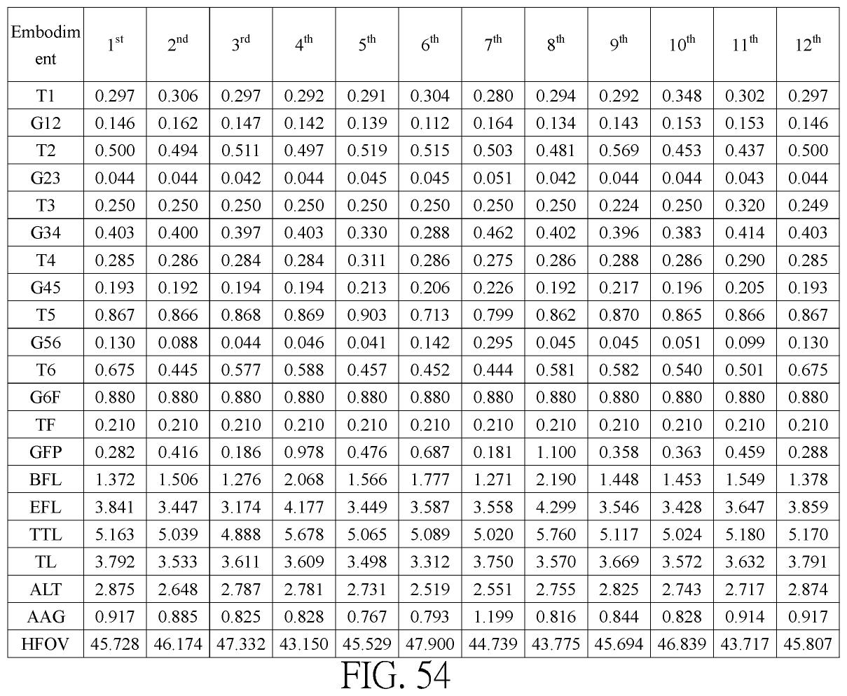

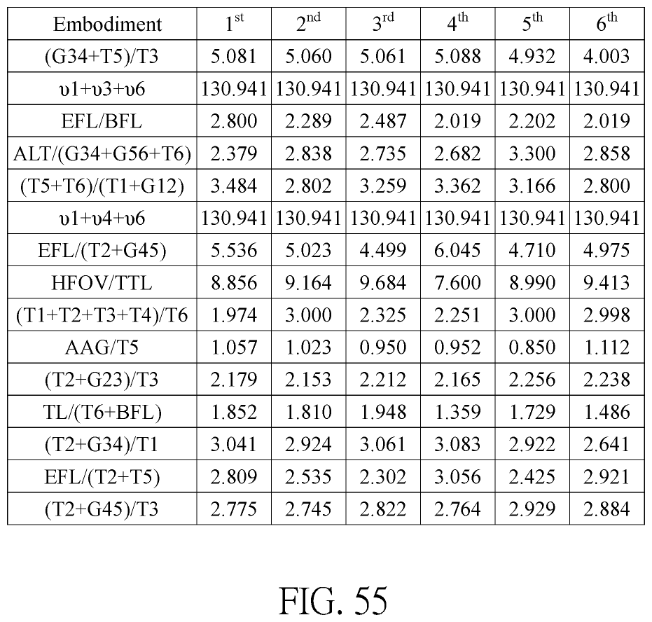

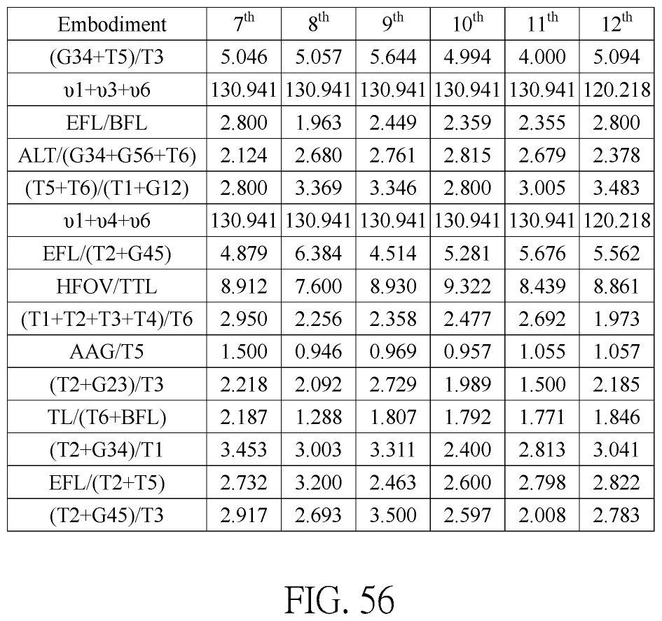

Some important ratios in each embodiment are shown in FIG. 54, in FIG. 55 and in FIG. 56. In addition, the embodiments of the present invention all satisfy the distance difference between the best focus planes of visible light and of infrared light may be less than 0.020 mm.

The embodiments of the present invention may provide the adjustment of each optical feature of lens elements, for example: 1. the periphery region of the object-side surface of the first lens element being concave and the optical axis region of the image-side surface of the first lens element being concave may recover rays of a large angle to go with the periphery region of the object-side surface of the second lens element being convex, the third lens element having negative refracting power and the fourth lens element having negative refracting power may modify the aberration. Moreover, the periphery region of the image-side surface of the fourth lens element being concave and the periphery region of the object-side surface of the fifth lens element being concave may correct the light path to be helpful to reduce the difference between the best focal planes of visible light and of infrared light.

2. With the optical features of lens elements in the embodiments of the present invention, for example:

the periphery region of the object-side surface of the first lens element being concave, the optical axis region of the image-side surface of the first lens element being concave may recover rays of a large angle. The aperture stop provided between the first lens element and the second lens element may have a large field of view without increasing the thickness of each lens elements while maintaining good imaging quality. When the second lens element having positive refracting power and the periphery region of the object-side surface of the second lens element being convex may correct the aberration of the first lens element, and further to go with the fourth lens element having negative refracting power, the optical axis region of the image-side surface of the fourth lens element being concave and the optical axis region of the object-side surface of the fifth lens element being concave may correct the light path to be helpful to reduce the difference between the best focal planes of visible light and of infrared light.

3. With each optical feature of lens elements in the embodiments of the present invention, for example:

the periphery region of the object-side surface of the first lens element being concave and the optical axis region of the image-side surface of the first lens element being concave may recover rays of a large angle. The aperture stop provided between the first lens element and the second lens element may have a large field of view without increasing the thickness of each lens elements while maintaining good imaging quality. When the periphery region of the object-side surface of the second lens element being convex may correct the aberration of the first lens element, to further go with the fourth lens element having negative refracting power, the optical axis region of the image-side surface of the fourth lens element being concave and the optical axis region of the object-side surface of the fifth lens element being concave may correct the light path to be helpful to reduce the difference between the best focal planes of visible light and of infrared light. The design of the periphery region of the image-side surface of the sixth lens element being convex may have the imaging rays precisely converged on the image plane after passing through the sixth lens element to enhance the imaging quality.

4. The further satisfaction of the embodiments of the present invention: the optical axis region of the image-side surface of the first lens element being concave, the third lens element having negative refracting power, the optical axis region of the object-side surface of the third lens element being convex, the fourth lens element having negative refracting power, the optical axis region of the image-side surface of the fourth lens element being concave, the optical axis region of the object-side surface of the fifth lens element being concave and the optical axis region of the object-side surface of the sixth lens element being convex satisfy HFOV/TTL≥8.000 degrees/mm may reduce the system length and enlarge the field of view. The further combination of either one of (a) the periphery region of the object-side surface of the fourth lens element being concave, the periphery region of the image-side surface of the fifth lens element being convex and v1+v3+v6≥120.000, (b) the periphery region of the image-side surface of the fifth lens element being convex, the sixth lens element having negative refracting power and v1+v3+v6≥120.000, (c) the periphery region of the object-side surface of the second lens element being convex and EFL/(T2+G45)≥4.400, either one may correct the light path to satisfy the object of the reduction of the difference between the best focus planes of visible light and of infrared light. The preferable range is 8.000 degrees/mm≤HFOV/TTL≤9.800 degrees/mm, 120.000≤v1+v3+v6≤135.000 and 4.400≤EFL/(T2+G45)≤6.500.

5. The embodiments of the present invention may satisfy an air gap between the third lens element and the fourth lens element along the optical axis greater than a thickness of the fourth lens element along the optical axis, or satisfy an air gap between the third lens element and the fourth lens element along the optical axis greater than a thickness of the third lens element along the optical axis, by increasing the air gap between the third lens element and the fourth lens element along the optical axis to correct the incident angle when the imaging rays enter the fourth lens element to correct the aberration and enhance the imaging quality.

6. By controlling EFL/BFL≤2.800, HFOV/TTL≥7.600 degrees/mm or EFL/(T2+T5)≤3.200, the embodiments of the present invention may increase the field of view. The preferable range is 1.800≤EFL/BFL≤2.800, 7.600 degrees/mm≤HFOV/TTL≤9.800 degrees/mm and 2.200≤EFL/(T2+T5)≤3.200.

7. The embodiments of the present invention may satisfy v1+v3+v6≥120.000 or v1+v4+v6≥120.000 so that the present invention may reduce the difference between the best focus planes of visible light and of infrared light while effectively reducing the chromatic sensitivity of the modulation transfer function (MTF). The preferable range is 120.000≤v1+v3+v6≤135.000 and 120.000≤v1+v4+v6≤135.000.

8. To reduce the system length and to ensure the imaging quality, air gaps between the adjacent lens elements or the thickness of each lens element may be reduced. Further satisfaction of the following conditional formulae of the optical imaging lens of the present invention may facilitate the better arrangement to take the fabrication difficulty into consideration:
(1) (G34+T5)/T3≥4.000, and the preferable range is 4.000≤(G34+T5)/T3≤5.700;
(2) ALT/(G34+G56+T6)≤3.300, and the preferable range is 2.000≤ALT/(G34+G56+T6)≤3.300;
(3) (T5+T6)/(T1+G12)≥2.800, and the preferable range is 2.800≤(T5+T6)/(T1+G12)≤3.600;
(4) EFL/(T2+G45)≥4.400, and the preferable range is 4.400≤EFL/(T2+G45)≤6.500;
(5) (T1+T2+T3+T4)/T6≤3.000, and the preferable range is 1.800≤(T1+T2+T3+T4)/T6≤3.000;
(6) AAG/T5≤1.500, and the preferable range is 0.700≤AAG/T5≤1.500;
(7) (T2+G23)/T3≥1.500, and the preferable range is 1.500≤(T2+G23)/T3≤2.900;
(8) TL/(T6+BFL)≤2.500, and the preferable range is 1.200≤TL/(T6+BFL)≤2.500;
(9) (T2+G34)/T1≥2.400, and the preferable range is 2.400≤(T2+G34)/T1≤3.600;
(10) (T2+G45)/T3≤3.500, and the preferable range is 2.000≤(T2+G45)/T3≤3.500.

9. The embodiments of the present invention may keep good imaging quality and have large field of view when the first lens element has negative refracting power. The production yield may be effectively increased when the periphery region of the object-side surface of the third lens element is convex, the periphery region of the image-side surface of the fifth lens element is convex or the optical axis region of the object-side surface of the sixth lens element is concave.

10. The light path which passes through the first lens element may be corrected to attain the objective of the reduction of the difference between the best focus planes of visible light and of infrared light while optimizing the aberration when the embodiments of the present invention satisfies: the optical axis region of the object-side surface of the second lens element is convex, the periphery region of the object-side surface of the second lens element is convex, the optical axis region of the image-side surface of the second lens element is convex or the periphery region of the image-side surface of the second lens element is convex.

Any arbitrary combination of the parameters of the embodiments can be selected additionally to increase the lens limitation so as to facilitate the design of the same structure of the present invention.

In the light of the unpredictability of the optical imaging lens, the above conditional formulas suggest that the optical imaging lens which has a confocal plane of visible light and of infrared light preferably enhances its half field of view and imaging quality while maintaining the system length, the lens injection molding and the assembly yield

In addition to the above ratios, one or more conditional formulae may be optionally combined to be used in the embodiments of the present invention and the present invention is not limit to this. The concave or convex configuration of each lens element or multiple lens elements may be fine-tuned to enhance the control of the performance or the resolution. The above limitations may be selectively combined in the embodiments without causing inconsistency.

The contents in the embodiments of the invention include but are not limited to a focal length, a thickness of a lens element, an Abbe number, or other optical parameters. For example, in the embodiments of the invention, an optical parameter A and an optical parameter B are disclosed, wherein the ranges of the optical parameters, comparative relation between the optical parameters, and the range of a conditional expression covered by a plurality of embodiments are specifically explained as follows:
(1) The ranges of the optical parameters are, for example, α₂≤A≤α₁ or β₂≤B≤β₁, where α₁ is a maximum value of the optical parameter A among the plurality of embodiments, α₂ is a minimum value of the optical parameter A among the plurality of embodiments, β₁ is a maximum value of the optical parameter B among the plurality of embodiments, and β₂ is a minimum value of the optical parameter B among the plurality of embodiments.
(2) The comparative relation between the optical parameters is that A is greater than B or A is less than B, for example.
(3) The range of a conditional expression covered by a plurality of embodiments is in detail a combination relation or proportional relation obtained by a possible operation of a plurality of optical parameters in each same embodiment. The relation is defined as E, and E is, for example, A+B or A−B or A/B or A*B or (A*B) ^{1/2}, and E satisfies a conditional expression E≤γ₁ or E≥γ₂ or γ₂≤E≤γ₁, where each of γ₁ and γ₂ is a value obtained by an operation of the optical parameter A and the optical parameter B in a same embodiment, γ₁ is a maximum value among the plurality of the embodiments, and γ₂ is a minimum value among the plurality of the embodiments.

The ranges of the aforementioned optical parameters, the aforementioned comparative relations between the optical parameters, and a maximum value, a minimum value, and the numerical range between the maximum value and the minimum value of the aforementioned conditional expressions are all implementable and all belong to the scope disclosed by the invention. The aforementioned description is for exemplary explanation, but the invention is not limited thereto.

The embodiments of the invention are all implementable. In addition, a combination of partial features in a same embodiment can be selected, and the combination of partial features can achieve the unexpected result of the invention with respect to the prior art. The combination of partial features includes but is not limited to the surface shape of a lens element, a refracting power, a conditional expression or the like, or a combination thereof. The description of the embodiments is for explaining the specific embodiments of the principles of the invention, but the invention is not limited thereto. Specifically, the embodiments and the drawings are for exemplifying, but the invention is not limited thereto.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical imaging lens, from an object side to an image side in order along an optical axis comprising: a first lens element, a second lens element, a third lens element, a fourth lens element, a fifth lens element, and a sixth lens element, the first lens element to the sixth lens element each having an object-side surface facing toward the object side and allowing imaging rays to pass through as well as an image-side surface facing toward the image side and allowing the imaging rays to pass through;
a periphery region of the object-side surface of the first lens element is concave, and an optical axis region of the image-side surface of the first lens element is concave;
a periphery region of the object-side surface of the second lens element is convex;
the third lens element has negative refracting power;
the fourth lens element has negative refracting power and a periphery region of the image-side surface of the fourth lens element is concave; and
a periphery region of the object-side surface of the fifth lens element is concave;
wherein lens elements included by the optical imaging lens are only the six lens elements described above.

2. The optical imaging lens of claim 1, wherein T3 is a thickness of the third lens element along the optical axis, T5 is a thickness of the fifth lens element along the optical axis and G34 is an air gap between the third lens element and the fourth lens element along the optical axis, and the optical imaging lens satisfies the relationship: (G34+T5)/T3≥4.000.

3. The optical imaging lens of claim 1, wherein v1 is an Abbe number of the first lens element, v3 is an Abbe number of the third lens element and v6 is an Abbe number of the sixth lens element, and the optical imaging lens satisfies the relationship: v1+v3+v6≥120.000.

4. The optical imaging lens of claim 1, wherein EFL is an effective focal length of the optical imaging lens and BFL is a distance from the image-side surface of the sixth lens element to an image plane along the optical axis, and the optical imaging lens satisfies the relationship: EFL/BFL≤2.800.

5. The optical imaging lens of claim 1, wherein ALT is a sum of thicknesses of all the six lens elements along the optical axis, T6 is a thickness of the sixth lens element along the optical axis, G34 is an air gap between the third lens element and the fourth lens element along the optical axis and G56 is an air gap between the fifth lens element and the sixth lens element along the optical axis, and the optical imaging lens satisfies the relationship: ALT/(G34+G56+T6)≤3.300.

6. The optical imaging lens of claim 1, wherein T1 is a thickness of the first lens element along the optical axis, T5 is a thickness of the fifth lens element along the optical axis, T6 is a thickness of the sixth lens element along the optical axis and G12 is an air gap between the first lens element and the second lens element along the optical axis, and the optical imaging lens satisfies the relationship: (T5+T6)/(T1+G12)≥2.800.

7. The optical imaging lens of claim 1, wherein v1 is an Abbe number of the first lens element, v4 is an Abbe number of the fourth lens element and v6 is an Abbe number of the sixth lens element, and the optical imaging lens satisfies the relationship: v1+v4+v6≥120.000.

8. An optical imaging lens, from an object side to an image side in order along an optical axis comprising: a first lens element, an aperture stop, a second lens element, a third lens element, a fourth lens element, a fifth lens element, and a sixth lens element, the first lens element to the sixth lens element each having an object-side surface facing toward the object side and allowing imaging rays to pass through as well as an image-side surface facing toward the image side and allowing the imaging rays to pass through;
a periphery region of the object-side surface of the first lens element is concave, and an optical axis region of the image-side surface of the first lens element is concave;
the second lens element has positive refracting power and a periphery region of the object-side surface of the second lens element is convex;
the fourth lens element has negative refracting power and an optical axis region of the image-side surface of the fourth lens element is concave; and
an optical axis region of the object-side surface of the fifth lens element is concave;
wherein lens elements included by the optical imaging lens are only the six lens elements described above.

9. The optical imaging lens of claim 8, wherein EFL is an effective focal length of the optical imaging lens, T2 is a thickness of the second lens element along the optical axis and G45 is an air gap between the fourth lens element and the fifth lens element along the optical axis, and the optical imaging lens satisfies the relationship: EFL/(T2+G45)≥4.400.

10. The optical imaging lens of claim 8, wherein HFOV is a half field of view of the optical imaging lens and TTL is a distance from the object-side surface of the first lens element to an image plane along the optical axis, and the optical imaging lens satisfies the relationship: HFOV/TTL≥7.600 degrees/mm.

11. The optical imaging lens of claim 8, wherein T1 is a thickness of the first lens element along the optical axis, T2 is a thickness of the second lens element along the optical axis, T3 is a thickness of the third lens element along the optical axis, T4 is a thickness of the fourth lens element along the optical axis and T6 is a thickness of the sixth lens element along the optical axis, and the optical imaging lens satisfies the relationship: (T1+T2+T3+T4)/T6≤3.000.

12. The optical imaging lens of claim 8, wherein AAG is a sum of five air gaps from the first lens element to the sixth lens element along the optical axis and T5 is a thickness of the fifth lens element along the optical axis, and the optical imaging lens satisfies the relationship: AAG/T5≤1.500.

13. The optical imaging lens of claim 8, wherein T2 is a thickness of the second lens element along the optical axis, T3 is a thickness of the third lens element along the optical axis and G23 is an air gap between the second lens element and the third lens element along the optical axis, and the optical imaging lens satisfies the relationship: (T2+G23)/T3≥1.500.

14. The optical imaging lens of claim 8, wherein TL is a distance from the object-side surface of the first lens element to the image-side surface of the sixth lens element along the optical axis, BFL is a distance from the image-side surface of the sixth lens element to an image plane along the optical axis and T6 is a thickness of the sixth lens element along the optical axis, and the optical imaging lens satisfies the relationship: TL/(T6+BFL)≤2.500.

15. An optical imaging lens, from an object side to an image side in order along an optical axis comprising: a first lens element, an aperture stop, a second lens element, a third lens element, a fourth lens element, a fifth lens element, and a sixth lens element, the first lens element to the sixth lens element each having an object-side surface facing toward the object side and allowing imaging rays to pass through as well as an image-side surface facing toward the image side and allowing the imaging rays to pass through;
a periphery region of the object-side surface of the first lens element is concave, and an optical axis region of the image-side surface of the first lens element is concave;
a periphery region of the object-side surface of the second lens element is convex;
the fourth lens element has negative refracting power and an optical axis region of the image-side surface of the fourth lens element is concave;
an optical axis region of the object-side surface of the fifth lens element is concave; and
a periphery region of the image-side surface of the sixth lens element is convex;
wherein lens elements included by the optical imaging lens are only the six lens elements described above.

16. The optical imaging lens of claim 15, wherein T1 is a thickness of the first lens element along the optical axis, T2 is a thickness of the second lens element along the optical axis and G34 is an air gap between the third lens element and the fourth lens element along the optical axis, and the optical imaging lens satisfies the relationship: (T2+G34)/T1≥2.400.

17. The optical imaging lens of claim 15, wherein EFL is an effective focal length of the optical imaging lens, T2 is a thickness of the second lens element along the optical axis and T5 is a thickness of the fifth lens element along the optical axis, and the optical imaging lens satisfies the relationship: EFL/(T2+T5)≤3.200.

18. The optical imaging lens of claim 15, wherein T2 is a thickness of the second lens element along the optical axis, T3 is a thickness of the third lens element along the optical axis and G45 is an air gap between the fourth lens element and the fifth lens element along the optical axis, and the optical imaging lens satisfies the relationship: (T2+G45)/T3≤3.500.

19. The optical imaging lens of claim 15, wherein an air gap between the third lens element and the fourth lens element along the optical axis is greater than a thickness of the fourth lens element along the optical axis.

20. The optical imaging lens of claim 15, wherein an air gap between the third lens element and the fourth lens element along the optical axis is greater than a thickness of the third lens element along the optical axis.
